(19) United States
(12) Patent Application Publication
(10) Pub. No.: US 2006/0033694 A1
(43) Pub. Date: Feb. 16, 2006

(54) Impedance conversion circuit, drive circuit, and control method therefor

(76) Inventor: Katsuhiko Maki, Chino (JP)

Correspondence Address: HARNESS, DICKEY & PIERCE, P.L.C., P.O. BOX 828, BLOOMFIELD HILLS, MI, 48303, US

(21) Appl. No.: 11/176,773

(22) Filed: Jul. 7, 2005

(30) Foreign Application Priority Data
Aug. 10, 2004 (JP) 2004-233674

(51) Int. Cl. G09G 3/36

(52) U.S. Cl. 345/89

(57) ABSTRACT

An impedance conversion circuit for outputting a voltage corresponding to (j+K) (j, k: positive integers) bits of gray scale data, including: an input for receiving an input voltage selected from 2^{j} levels of voltages in accordance with high j bit(s) of the gray scale data; and an output for outputting an output voltage corresponding to low k bit(s) of the gray scale data from 2^{k} levels of voltages obtained by changing a potential of the input voltage.

### BACKGROUND OF THE INVENTION

1. Technical Field

The present invention relates to an impedance conversion circuit, a drive circuit, and a control method for the impedance circuit.

2. Related Art

In the related art, as liquid crystal panels (electro-optic devices, in a broad sense) used for electronic apparatuses such as mobile phones, simple matrix liquid crystal panels and active matrix liquid crystal panels using switching elements such as thin film transistors (hereinafter abbreviated as TFT) are known.

The simple matrix method has an advantage that low power consumption can more easily be achieved compared to the active matrix method on the one hand, and has a disadvantage that multi-colored images or movies are difficult to be displayed on the other hand. In contrast, the active matrix method has an advantage that it is suitable for displaying multi-colored images or movies on the one hand, and has a disadvantage that low power consumption is difficult to be achieved on the other hand.

Further, in the recent years, needs to display multi-colored images or movies for portable electronic apparatuses such as mobile phones increase in order to provide high quality images. Accordingly, the simple matrix liquid crystal panels used in the related art have gradually been replaced with the active matrix liquid crystal panels.

In the active matrix liquid crystal panel, an impedance conversion circuit as an output buffer is preferably provided in a data driver (a drive circuit, in a broad sense) for driving a data line of the liquid crystal panel. The impedance conversion circuit includes an operational amplifier, and is able to stably supplying voltage to the data line with its high drive efficiency.

The impedance conversion circuit supplies a gray scale voltage corresponding to gray scale data (data, in a broad sense). In this case, the gray scale voltage is selected from a number of predetermined voltage levels in accordance with the gray scale data, and the impedance conversion circuit to which the gray scale voltage is supplied droves the data line.

The impedance conversion circuit thus driving the data line is provided corresponding to each of the data lines. Therefore, the number of the impedance conversion circuits is disposed as shown in FIG. 22 with respect to the direction of arrangement of the data lines.

In the case of FIG. 22, a reference voltage generating circuit 800 generates a number of gray scale voltages V0 through V63 corresponding to the 6 bit gray scale data. The reference voltage generating circuit 800 generates the number of gray scale voltages V0 through V63 by dividing a voltage between the system power source voltage VDD and the system ground power source voltage VSS using resister elements.

In order for supplying the number of gray scale voltages V0 through V63 thus generated to the impedance conversion circuit, a group of gray scale voltage signal lines is disposed extending in the arrangement direction of the data lines. An input terminal of each of the impedance conversion circuits is electrically connected to either one of the gray scale voltage signal lines in accordance with the gray scale data. An example of the related art is disclosed in Japanese Unexamined Patent Publication No. 2003-233354.

Incidentally, multi-gray scale display is required for improving the image display quality of liquid crystal panels. The enhancement of the multi-gray scale display requires increase in the number of levels of the gray scale voltages. Therefore, it leads increase in the number of signal lines of the group of gray scale voltage signal lines shown in FIG. 22. Therefore, if the multi-gray scale display is enhanced, the total width WD of a wiring region for the group of the gray scale voltage signal lines shown in FIG. 22 should further be enlarged.

For example, the wiring region width WD for the case in which the gray scale data for one dot is expressed with 6 bits (namely 64 gray scale levels) is considered. In the case shown in FIG. 23B, for example, the gray scale voltage signal lines are disposed alternately on a first wiring layer and a second wiring layer to minimize the wiring capacity between the gray scale voltage signal lines adjacent to each other. In this case, as shown in FIG. 23A, it is assumed that the width of each of the signal lines is 1.25 μm and the design rule distance between the signal lines is 0.3 μm. In this case, the wiring region width WD becomes about 100 μm (≈1.25 μm×64+0.3 μm×63). Therefore, if the bit number of the gray scale data for one dot is increased to be, for example, 256 gray scale levels, the wiring region width WD reaches as large as about 400 μm.

As described above, the wiring region of the group of gray scale voltage signal lines is extended along the direction of the data line arrangement on the one hand, its width is enlarged as the multi-gray scale display is enhanced on the other hand. As described above, the wiring region for the group of the gray scale voltage signals occupies a part of the whole data driver area at a large ratio. Therefore, the ratio at which the wiring region for the group of gray scale voltage signals occupies becomes larger and larger as the multi-gray scale display enhances, thus causing high manufacturing cost due to the enlarged area for layout.

### SUMMARY

In view of the above technical problems, an advantage of the present invention is to provide an impedance conversion circuit, a driver circuit, and a method of controlling the impedance conversion circuit each capable of reducing the number of gray scale voltage signal lines while maintaining the number of gray scale levels.

In view of the problems, an aspect of the invention relates to an impedance conversion circuit for outputting a voltage corresponding to (j+k) (j, k: positive integers) bits of gray scale data, including an input for receiving an input voltage selected from 2^{j} levels of voltages in accordance with high j bit(s) of the gray scale data, and an output for outputting an output voltage corresponding to low k bit(s) of the gray scale data from 2^{k} levels of voltages obtained by changing a potential of the input voltage.

In this aspect of the invention, either of the 2^{j} levels of voltage corresponding to the high j bits data of (j+k) bits gray scale data is received as the input voltage, and the impedance conversion circuit outputs the voltage corresponding to low k bits of the gray scale data from the 2^{k} levels of voltages based on the input voltage. Therefore, it is enough to select the input voltage from the 2^{j} levels of gray scale voltages. Thus, since the number of gray scale voltage signal lines can be reduced while maintaining the number of gray scale levels, the number of gray scale voltages to be generated can be reduced. And, the number of gray scale voltage signal lines supplied with the generated gray scale voltages can be reduced, thus making the width of the wiring region narrower. As a result, the ratio of the area the wiring region for the gray scale voltage signal lines occupies can be held in a low level. Thus, even with an increased number of gray scale levels, the chip area of the data driver implementing the impedance conversion circuit can be reduced to achieve cost reduction.

Further, in an impedance conversion circuit according to another aspect the invention, an operational amplifier connected to form a voltage follower and having an input supplied with the input voltage, and an output voltage setting circuit for pre-charging or discharging an output of the operational amplifier in accordance with the least significant bit data of the gray scale data can also be included. The operational amplifier outputs the output voltage different from the input voltage by a dead zone width of the operational amplifier after the output voltage setting circuit pre-charges or discharges the output of the operational amplifier.

Further, in the impedance conversion circuit according to another aspect of the invention, the source of each transistor is supplied with a current from the first current source. The operational amplifier can include a first differential amplifier circuit of a first conductivity type having a first differential transistor pair of the first conductivity type and a first current mirror circuit, a second differential amplifier circuit of a second conductivity type having a second differential transistor pair of the second conductivity type and a second current mirror circuit, and an output circuit having a first drive transistor of the second conductivity type and a second drive transistor of the first conductivity type.

The gate of the each of the first differential transistor pair of the first conductivity type is respectively supplied with the input voltage and the output voltage. The first current mirror circuit generates a drain current for each transistor of the first differential transistor pair. The source of each of the transistors of the second differential transistor pair of the second conductivity type is supplied with a current from the second current source, and the gate of each of the transistors is respectively supplied with the input voltage and the output voltage. The second current mirror circuit generates a drain current for each transistor of the second differential transistor pair.

The gate voltage of the first drive transistor of the second conductivity type is controlled in accordance with the drain voltage of the input side of the transistors forming the first differential transistor pair. The gate of the input side of the transistors is supplied with the input voltage. Further, the gate voltage of the second drive transistor of the first conductivity type is controlled in accordance with the drain voltage of the input side of the transistors forming the second differential transistor pair. The gate of the input side of the transistors is supplied with the input voltage. The output circuit outputs a voltage of the node through which the drains of the first and the second drive transistors are connected to each other. A current drive efficiency of the input side of the first pair of transistors is arranged to be lower than a current drive efficiency of the other, namely the output side of the first pair of transistors. A current drive efficiency of the input side of the second pair of transistors is arranged to be lower than a current drive efficiency of the other, namely the output side of the second pair of transistors.

The operational amplifier according to the present aspect of the invention is supposed to be designed so as to eliminate the output dead zone. However, in the present aspect of the invention, since the configuration having a dead zone is adopted by design to actively utilize the dead zone, two kinds of output voltages can be output with respect to the single level of input voltage with a simple configuration. Therefore, by applying this impedance conversion circuit to an impedance conversion device of the data driver, the number of gray scale voltage levels to be generated by the reference voltage generating circuit 527 can be reduced by half

Further, in the impedance conversion circuit according to still another aspect of the invention, an operational amplifier connected to form a voltage follower and output voltage setting circuit can also be included. An input of the operational amplifier is supplied with the input voltage. The operational amplifier is also provided with a dead zone having a width corresponding to low (k−1) bit(s) data of a low k bits of the gray scale data. The output voltage setting circuit pre-charges or discharges the output of the operational amplifier in accordance with the most significant bit data of the low k bits of the gray scale data. And, the operational amplifier outputs the output voltage different from the input voltage by a dead zone width of the operational amplifier after the output voltage setting circuit pre-charges or discharges the output of the operational amplifier.

Further in the impedance conversion circuit according to still another aspect of the invention, the operational amplifier can include a first differential amplifier circuit of a first conductivity type having a first differential transistor pair of the first conductivity type and a first current mirror circuit, a second differential amplifier circuit of a second conductivity type having a second differential transistor pair of the second conductivity type and a second current mirror circuit, and an output circuit having a first drive transistor of the second conductivity type and a second drive transistor of the first conductivity type. The source of each of the transistors of the first differential transistor pair of the first conductivity type is supplied with a current from the first current source, and the gate of each of the transistors is respectively supplied with the input voltage and the output voltage. The first current mirror circuit generates a drain current for each transistor of the first differential transistor pair. The source of each of the transistors of the second differential transistor pair of the second conductivity type is supplied with a current from the second current source, and the gate of each of the transistors is respectively supplied with the input voltage and the output voltage. The second current mirror circuit generates a drain current for each transistor of the second differential transistor pair. Further, the gate voltage of the first drive transistor of the second conductivity type is controlled in accordance with the drain voltage of the input side of the transistors forming the first differential transistor pair. The gate of the input side of the transistors is supplied with the input voltage. The gate voltage of the second drive transistor of the first conductivity type is controlled in accordance with the drain voltage of the input side of the transistors forming the second differential transistor pair. The gate of the input side of the transistors is supplied with the input voltage. The output circuit outputs a voltage of the node through which the drains of the first and the second drive transistors are connected to each other. In this case, a first current drive efficiency of the input side of the first pair of transistors is arranged to be lower than a first current drive efficiency of the other, namely the output side of the first pair of transistors. Further, the dead zone width is changed by changing the difference in the current drive efficiencies of the first input side and output side in accordance with low (k−1) bit(s) data of low k bits of the gray scale data. A second current drive efficiency of the input side of the second pair of transistors is arranged to be lower than a second current drive efficiency of the other, namely the output side of the second pair of transistors. And, the dead zone width is changed by changing the difference in the current drive efficiencies of the second input side and output side in accordance with low (k−1) bit(s) data of low k bits of the gray scale data.

According to this aspect of the invention, since it is arranged to change the dead zone width by changing the difference in the current drive efficiencies of the transistors forming the differential transistor pair in accordance with the gray scale data, the impedance conversion circuit capable of outputting four or more kinds of voltages with respect to a single input voltage with a simple configuration can be provided. Thus, the chip size of the data driver implementing this impedance conversion circuit can further be reduced to achieve further reduction of the cost.

Further, in the impedance conversion circuit according to still another aspect of the invention, the first differential amplifier circuit of the first conductivity type can include a first auxiliary transistor whose gate is supplied with the input voltage. And, a source or a drain of the first auxiliary transistor can be electrically connected or disconnected between the source and the drain of the input side of the first pair of transistors in accordance with the low (k−1) bit(s) data of the low k bits of the gray scale data.

Further, in the impedance conversion circuit according to still another aspect of the invention, the second differential amplifier circuit of the second conductivity type can include a second auxiliary transistor whose gate is supplied with the input voltage. In this case, a source or a drain of the second auxiliary transistor is electrically connected or disconnected between the source and the drain of the input side of the second pair of transistors in accordance with the low (k−1) bit(s) data of the low k bits of the gray scale data.

Further, in the impedance conversion circuit according to still another aspect of the invention, the first differential amplifier circuit of the first conductivity type can include a third auxiliary transistor whose gate is supplied with the output voltage. In this case, a source or a drain of the third auxiliary transistor is electrically connected or disconnected between the source and the drain of the output side of the first pair of transistors in accordance with the low (k−1) bit(s) data of the low k bits of the gray scale data.

Further, in the impedance conversion circuit according to still another aspect of the invention, the second differential amplifier circuit of the second conductivity type can include a fourth auxiliary transistor whose gate is supplied with the output voltage. In this case, a source or a drain of the fourth auxiliary transistor is electrically connected or disconnected between the source and the drain of the output side of the second pair of transistors in accordance with the low (k−1) bit(s) data of the low k bits of the gray scale data.

In this aspect of the invention, the auxiliary transistor to which the input voltage or the output voltage is supplied as the gate voltage is provided. And the auxiliary transistor is electrically connected or disconnected to either of the transistors composing the differential transistor pair in accordance with the low (k−1) bits data of the gray scale data. Thus, the difference in the current drive efficiencies of the both transistors forming the differential transistor pair can easily be changed. Accordingly, the impedance conversion circuit capable of outputting four or more levels of voltage with respect to a single input voltage with a simple configuration can be provided.

Further, in the impedance conversion circuit according to the present aspect of the invention, the output voltage setting circuit can set the output of the operational amplifier to a pre-charge voltage higher than the input voltage in a pre-charge state, and sets the output of the operational amplifier to a discharge voltage lower than the input voltage in a discharge state.

Further, still another aspect of the invention relates to a driver circuit for driving an electro-optic device having a plurality of scanning lines, a plurality of data lines, a plurality of pixel electrodes specified by the scanning lines and the data lines, including either of the impedance conversion circuits described above, and a voltage selecting circuit for outputting a voltage selected from 2^{j} levels of voltages in accordance with high j bit(s) of the gray scale data as the input voltage. In this case, the driver circuit supplies either of the plurality of data lines with the output voltage.

Further, still another aspect of the invention relates to a driver circuit for driving an electro-optic device having a plurality of scanning lines, a plurality of data lines, a plurality of pixel electrodes specified by the scanning lines and the data lines, including either of the impedance conversion circuits described above, and a voltage selecting circuit for outputting a voltage selected from 2^{j} levels of voltages in accordance with high j bit(s) of the gray scale data as the input voltage. In this case, the output voltage setting circuit pre-charges or discharges the output of the operational amplifier in the beginning period (a first period) of a driving period, and the operational amplifier supplies either of the plurality of data lines with the output voltage in a second period of the driving period after the first period.

Further, in the driver circuit according to still another aspect of the invention, a reference voltage generating circuit for generating 2^{j} levels of voltages obtained by dividing a voltage between the first and the second power supply voltages can be included.

According to this aspect of the invention, the driver circuit including the impedance circuit capable of reducing the number of the gray scale voltage signal lines while maintaining the number of gray scale levels can be provided. Accordingly, the area of the chip of the driver circuit can be decreased, thus realizing reduction of the cost.

Further, still another aspect of the invention relates to a method of controlling an impedance conversion circuit for outputting a voltage corresponding to p (p: positive integer, equal to or greater than two) bits of gray scale data. The method includes the step of pre-charging or discharging an output of an operational amplifier in accordance with the least significant bit data of the gray scale data. The operational amplifier is connected to form a voltage follower whose input is supplied with an input voltage selected from 2^{p} levels of voltages in accordance with high (p−1) bit(s) data of the gray scale data. The method further includes the step of outputting by the operational amplifier a voltage different from the input voltage by the dead zone width of the operational amplifier. The outputting step is executed after the pre-charging/discharging step.

Further, still another aspect of the invention relates to a method of controlling an impedance conversion circuit for outputting a voltage corresponding to (j+k) (j, k: positive integers) bits of gray scale data. The method includes the step of pre-charging or discharging an output of an operational amplifier in accordance with the most significant bit data of low k bits of the gray scale data. The operational amplifier is connected to form a voltage follower whose input is supplied with an input voltage selected from 2^{j} levels of voltages in accordance with high j bit(s) data of the gray scale data. The method further includes the step of outputting by the operational amplifier a voltage different from the input voltage by the dead zone width in accordance with the low (k−1) bit(s) of low k bits of the gray scale data. The outputting step is executed after the pre-charging/discharging step.

### BRIEF DESCRIPTION OF THE DRAWINGS

The invention will now be described with reference to the accompanying drawings, wherein like reference numerals denotes like elements, and wherein:

FIG. 1 is a block diagram of a liquid crystal device implementing an impedance conversion circuit according to the present embodiment.

FIG. 2 is a block diagram of a configuration example of a data driver shown in FIG. 1.

FIG. 3 is a block diagram of a configuration example of a scan driver shown in FIG. 1.

FIG. 4 is a configuration diagram showing an example of a substantial part of the data driver according to the present embodiment.

FIG. 5 is a schematic diagram for explaining a configuration of the gray scale data for each dot.

FIG. 6 is a schematic diagram showing an operational example of the impedance conversion circuit according to the present embodiment.

FIG. 7 is a schematic diagram showing an other operational example of the impedance conversion circuit according to the present embodiment.

FIG. 8 is a schematic diagram showing an example of a gray scale characteristic of the data driver according to the present embodiment.

FIG. 9 is a block diagram showing a schematic configuration of the impedance conversion circuit of a first configuration example of the present embodiment.

FIG. 10 is a timing chart of an operational example of the impedance conversion circuit shown in FIG. 9.

FIG. 11 is a circuit diagram of a configuration example of the operational amplifier in the first configuration example of the present embodiment.

FIG. 12 is a schematic diagram of a configuration of the operational amplifier and the output voltage setting circuit of the first configuration example in a discharged state.

FIG. 13 is a schematic diagram showing an example of an operational waveform of the output voltage of the operational amplifier shown in FIG. 12.

FIG. 14 is a schematic diagram of a configuration of the operational amplifier and the output voltage setting circuit of the first configuration example in a pre-charged state.

FIG. 15 is a schematic diagram showing an example of an operational waveform of the output voltage of the operational amplifier shown in FIG. 14.

FIG. 16 is a block diagram showing a schematic configuration of the impedance conversion circuit of a second configuration example of the present embodiment.

FIG. 17 is a timing chart of an operational example of the impedance conversion circuit shown in FIG. 16.

FIG. 18 is a circuit diagram of a configuration example of the operational amplifier in the second configuration example of the present embodiment.

FIG. 19 is a schematic drawing for explaining a control example of the switching elements when k equals two.

FIG. 20 is a circuit diagram of a configuration example of the operational amplifier in a modified example of the second configuration example.

FIG. 21 is a schematic drawing for explaining a control example of the switching elements when k equals two.

FIG. 22 is a schematic diagram for explaining the relationship between the arranging direction of the impedance conversion circuits and the arranging direction of the data lines.

FIGS. 23A and 23B are schematic diagrams for explaining the wiring region for the group of gray scale voltage signal lines.

### DESCRIPTION OF THE EMBODIMENTS

Hereinafter, an embodiment of the invention is described in detail with reference to the accompanying drawings. Note that the embodiment described below does not unreasonably limit the content of the invention as claimed in the claim section. Further, not all of the components of the configuration described below are essential elements of the invention.

1. Liquid Crystal Device

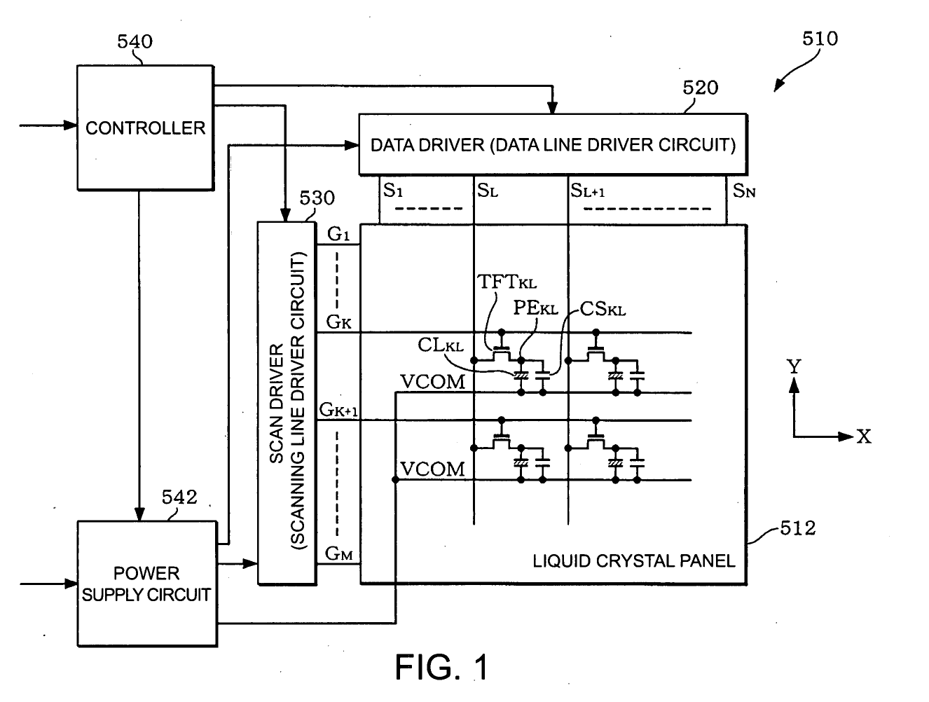

FIG. 1 shows an example of a block diagram of a liquid crystal device implementing an impedance conversion circuit according to the present embodiment.

The liquid crystal device (a display device, in a broad sense) 510 includes a liquid crystal panel (a display panel, in a broad sense) 512, a data driver (a data line driver circuit) 520, a scan driver (a scanning line driver circuit) 530, a controller 540, and a power source circuit 542. Note that the liquid crystal device does not necessarily include all of these circuit blocks, but a configuration without a part of these circuit blocks can also be adopted.

In this case, the display panel (in a broad sense, a display panel or an electro-optic device) 512 includes a plurality of scanning lines (in a narrow sense, gate lines), a plurality of data lines (in a narrow sense, source lines), and a number of pixel electrodes specified by the plurality of scanning lines and the plurality of data lines. In this case, an active matrix type of liquid crystal display device can be composed by connecting to the data line a thin film transistor TFT (in a broad sense, a switching element) connected to the pixel electrode.

More specifically, the liquid crystal panel 512 is formed on an active matrix substrate (e.g., a glass substrate). On the active matrix substrate, there are disposed scanning lines G₁ through G_{M} (M denotes a natural number equal to or greater than two.) arranged in the Y direction in FIG. 1 and each extending in the X direction and data lines S₁ through S_{N} (N denotes a natural number equal to or greater than two.) arranged in the X direction and each extending in the Y direction. Further, a thin film transistor TFT_{KL} (in a broad sense, a switching element) is provided at a position corresponding to the intersection of the scanning line G_{K} (1≦K≦M, K denotes a natural number.) and the data line S_{L} (1≦L≦N, L denotes a natural number.).

The gate electrode of the TFT_{KL} is connected to the scanning line G_{K}, the source electrode of the TFT_{KL} is connected to the data line S_{L}, and the drain electrode of the TFT_{KL} is connected to the pixel electrode PE_{KL}. A liquid crystal capacitance CL_{KL} (a liquid crystal element) and an auxiliary capacitance CS_{KL} are formed between the pixel electrode PE_{KL} and an opposing electrode (a common electrode) VCOM facing the pixel electrode PE_{KL} across a liquid crystal element (in a broad sense, an electro-optic material). And, the liquid crystal material is enclosed between the active matrix substrate, on which the TFT_{KL}, the pixel electrode PE_{KL}, and so on are formed, and the opposing substrate with the opposing electrode VCOM formed thereon so that the transmittance of the pixel changes in accordance with the voltage applied between the pixel electrode PE_{KL} and the opposing electrode VCOM.

Note that the common electric potential applied to the opposing electrode VCOM is generated by the power supply circuit 542. Further, the opposing electrode VCOM is not necessarily formed over the surface of the opposing substrate, but can be formed like strips respectively corresponding to each of the scanning lines.

The data driver 520 drives the data lines S₁ through S_{N} of the liquid crystal panel 512 in accordance with the gray scale data. Meanwhile, the scan driver 530 sequentially scans the scanning lines G₁ through G_{M} of the liquid crystal panel 512.

The controller 540 controls the data driver 520, the scan driver 530, and the power supply circuit 542 based on the contents set by a host such as a central processing unit (CPU) not shown in the drawings.

More specifically, the controller 540 executes on the data driver 520 and the scan driver 530, for example, setting of the operational mode or supplying with the a vertical sync signal and a horizontal sync signal generated inside thereof, and executes on the power supply circuit 542 controlling the polarization reversing timing of the common potential of the opposing electrode VCOM.

The power supply circuit 542 generates various voltages necessary for driving the liquid crystal panel 512 and the common potential of the opposing electrode VCOM based on a reference voltage supplied externally.

Note that, although the liquid crystal device 510 has a configuration including the controller 540 in FIG. 1, the controller 540 can also be provided outside the liquid crystal device 510. Alternatively, the liquid crystal device 510 can include the host in combination with the controller 540. Further, a part or the whole of the data driver 520, the scan driver 530, the controller 540, and the power supply 542 can be formed on the liquid crystal panel 512.

1.1 Data Line Driver Circuit

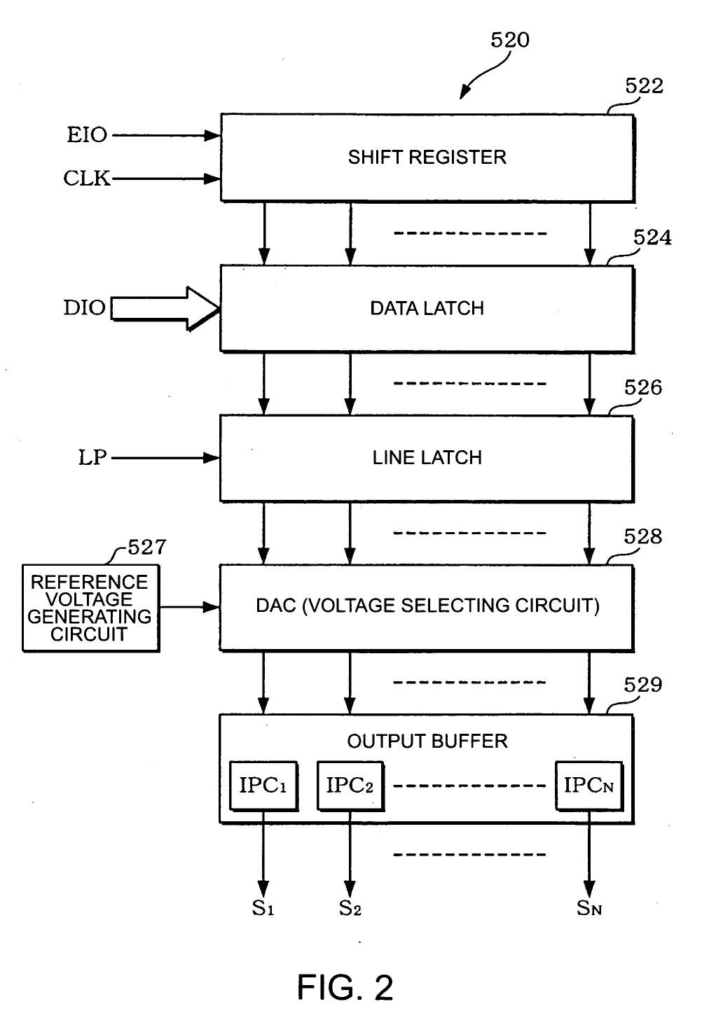

FIG. 2 shows a configuration example of the data driver 520 shown in FIG. 1.

The data driver 520 includes a shift register 522, a data latch 524, a line latch 526, a reference voltage generating circuit 527, DAC 528 (a digital to analogue converter circuit, a voltage electing circuit, in a broad sense), and an output buffer 529.

The shift register 522 is provided correspondingly to each of the data lines and includes a plurality of flip-flops connected in series. The shift register 522 acquires an input/output enable signal EIO in sync with a clock signal CLK, and then sequentially shifts the input/output enable signal EIO to the adjacent flip-flop in sync with the clock signal CLK.

The gray scale data (DIO) is input to the data latch 524 in the unit of, for example, 18 bits (6 bits (gray scale data) multiplied by 3 (RGB colors)) from the controller 540. The data latch 524 latches the gray scale data (DIO) in sync with the input/output enable signal EIO sequentially shifted by each of the flip-flops of the shift register 522.

The line latch 526 latches, in sync with the horizontal sync signal LP supplied from the controller 540, one horizontal scanning unit of the gray scale data latched by the data latch 524.

The reference voltage generating circuit 527 generates a number of reference voltages (gray scale voltages) each corresponding to either one of the values of the gray scale data. The reference voltage generating circuit 527 includes a gamma correction resistor, and outputs, as the gray scale voltages, voltages obtained by dividing the potential difference between both edges of the gamma correction resistor using resistor elements. Therefore, the gray scale voltages corresponding to the gray scale data can be adjusted by tuning the resistance ratio of the resistor elements, thus realizing so-called gamma correction.

The DAC 528 generates analogous gray scale voltages to be supplied to the data lines. Specifically, the DAC 528 selects either one gray scale voltage from a number of gray scale voltages generated by the reference voltage generating circuit 527 in accordance with the digital gray scale data (digital data) from the line latch 526, and output it as analogous gray scale data corresponding to the digital gray scale data (digital data).

The output buffer 529 buffers the gray scale voltages from the DAC 528 to output them to the data lines, and drives the data lines. Specifically, the output buffer 529 includes the impedance conversion circuits IPC₁ through IPC_{N}, each performing impedance conversion of the gray scale voltages from the DAC 528, and outputting them on the respective data lines. Each of the impedance conversion circuits is composed of an operational amplifier (Op-Amp) connected as a voltage follower.

1.2 Scan Driver

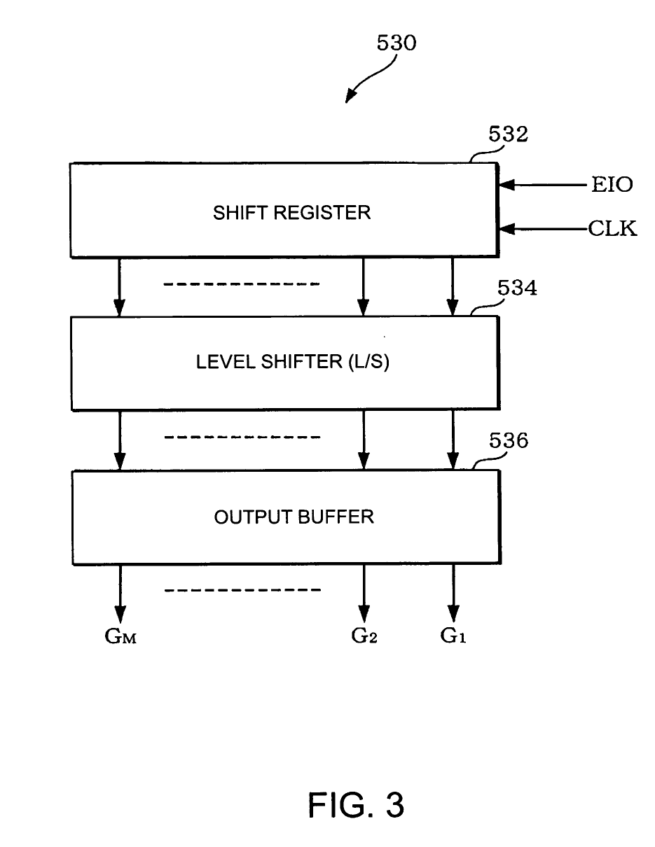

FIG. 3 shows a configuration example of the scan driver 530 shown in FIG. 1.

The scan driver 530 includes a shift register 532, a level shifter 534, and an output buffer 536.

The shift register 532 is provided correspondingly to each of the scanning lines and includes a plurality of flip-flops connected in series. The shift register 532 acquires an input/output enable signal EIO in sync with a clock signal CLK, and then sequentially shifts the input/output enable signal EIO to the adjacent flip-flop in sync with the clock signal CLK. Note that the input/output enable signal EIO input thereto is a vertical sync signal supplied from the controller 540.

The level shifter 534 shifts the voltage level of the shift register 532 to a voltage level suitable for the liquid crystal element of the liquid crystal panel 512 and the capacity of the TFT as a transistor. As the voltage level, for example, a rather high voltage level of 20 through 50 volt is required.

The output buffer 536 buffers the scanning voltages shifted by the level shifter 534, outputs them to the scanning lines, and drives the scanning lines.

2. Impedance Conversion Circuit

By using the impedance conversion circuit of the present embodiment, the number of gray scale voltage signal lines can be reduced while maintaining the number of gray scale levels.

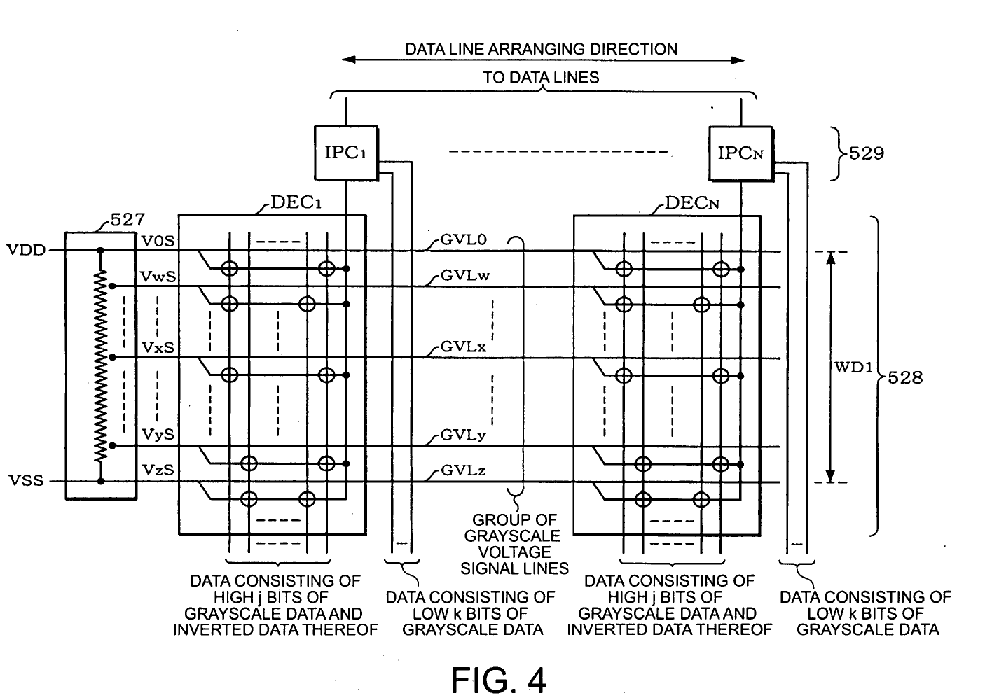

FIG. 4 shows a configuration example of a substantial part of the data driver according to the present embodiment. Note that the same parts as those of the data driver 520 shown in FIG. 2 are denoted with the same reference numerals and explanations therefor are omitted if appropriate.

The reference voltage generating circuit 527 includes the gamma correction resistor. The gamma correction resistor outputs voltages obtained by resistively dividing the potential difference between the system power supply voltage VDD (a first power supply voltage) and the system ground power supply voltage VSS (a second power supply voltage) as the gray scale voltages V0S, VwS, . . . , VxS, . . . , VyS, VzS.

The gray scale voltage signal lines GVL0, GVLw, . . . , GVLx, . . . , GVLy, GVLz are respectively supplied with the gray scale voltages V0S, VwS, . . . , VxS, . . . , VyS, VzS.

The DAC 528 includes the first through N^{th} decoder DEC₁ through DEC_{N} each provided for respective one of the data lines. Each of the decoders selects from the gray scale voltages V0S, VwS, . . . , VxS, . . . , VyS, VzS the gray scale voltage corresponding to high j bits of (j+k) (j and k are positive integers.) bits of gray scale data corresponding to the data line. For example, each of the decoders is composed of a so-called ROM, and selects either one of the gray scale voltages V0S, VwS, . . . , VxS, . . . VyS, VzS from the reference voltage generating circuit 527 in accordance with the high j bits data of the gray scale data and the inverted data thereof.

The output buffer 529 includes the impedance conversion circuits IPC₁ through IPC_{N} provided for respective data lines. The impedance conversion circuit IPCₕ (1≦h≦N, h denotes an integer.) is supplied with the gray scale voltage selected by the h^{th} decoder DECₕ as an input voltage. Namely, the impedance conversion circuit IPCₕ is supplied as its input voltage with the voltage selected from 2^{j} kinds of voltages in accordance with the high j bits data of the gray scale data. And, the impedance conversion circuit IPCₕ outputs to the data line Sₕ a voltage corresponding to the low k bits data of the gray scale data selected from 2^{k} kinds of voltages obtained by modifying the potentials of the input voltages.

By thus processed, the number of gray scale voltage signal lines connected to the respective decoders DAC 528 can be 2^{j} in the present embodiment while it is 2^{(j+k)} in the case of, for example, FIG. 22.

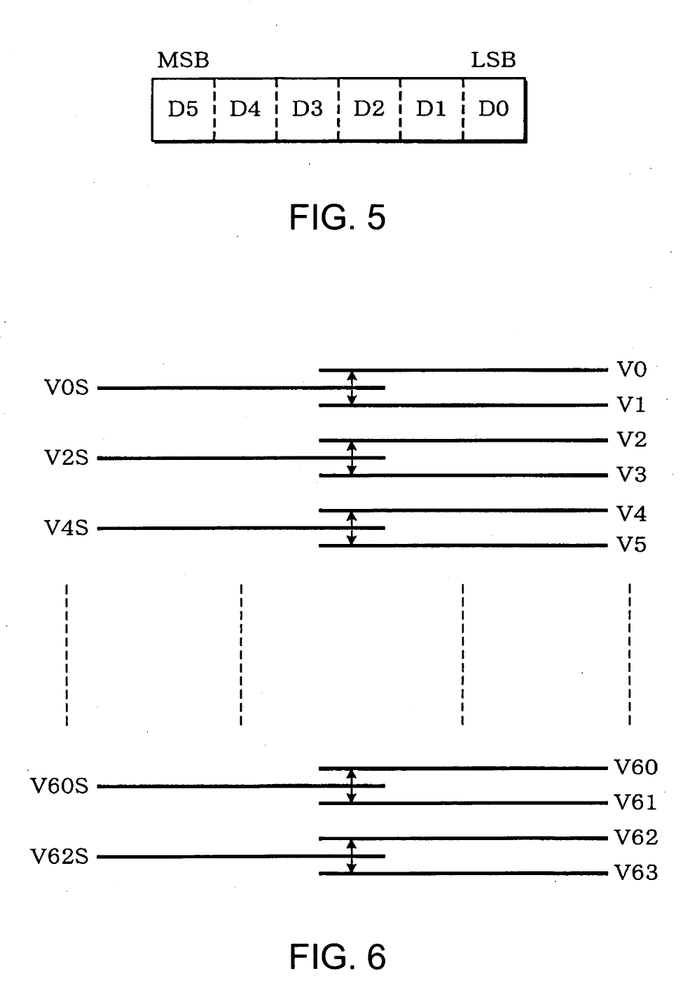

FIG. 5 shows a configuration example of gray scale data for one dot.

The gray scale data shown in FIG. 5 is generated for each of the data lines. And, the gray scale data is composed of 6 bits wherein the most significant bit is denoted with D5 while the least significant bit is denoted with D0. Using the gray scale data thus configured, 64 gray scale levels for one dot can be realized.

FIG. 6 shows an operational example of the impedance conversion circuit according to the present embodiment.

FIG. 6 shows the operational example of the case in which the impedance conversion circuit shown in FIG. 4 outputs, as the output voltage, a voltage corresponding to the least significant bit of data in, for example, 6 bits of gray scale data. Namely, the case in which k equals one is shown. In this case, the impedance conversion circuit shown in FIG. 4 outputs either one of 2¹ kinds of voltage levels as the output voltage.

If 64 levels of gray scale are expressed, the impedance conversion circuit needs to output the gray scale voltages V0 through V63. In this case, an input voltage to the impedance conversion circuit can be either one of the gray scale voltages V0S, V2S, V4S, . . . , V60S, V62S. Therefore, it is enough that the decoder for selecting the input voltage of the impedance conversion circuit is connected to the group of gray scale voltage signal lines supplied with the gray scale voltages V0S through V62S. Namely, it is enough that the number of gray scale voltages generated by the reference voltage generating circuit 527 is 32.

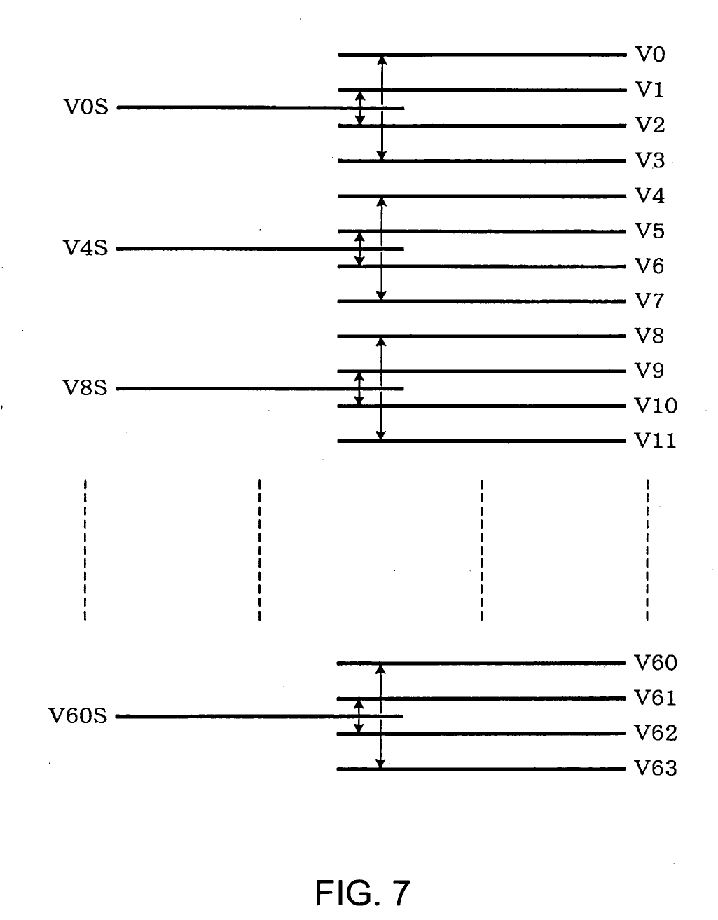

FIG. 7 shows another operational example of the impedance conversion circuit according to the present embodiment.

FIG. 7 shows the operational example of the case in which the impedance conversion circuit shown in FIG. 4 outputs, as the output voltage, a voltage corresponding to the low two bits of data in, for example, 6 bits of gray scale data. Namely, the case in which k equals two is shown. In this case, it is enough that the impedance conversion circuit shown in FIG. 4 outputs either one of 22 kinds of voltage levels as the output voltage.

If 64 levels of gray scale are expressed, it is enough that the input voltage to the impedance conversion circuit is either one of the gray scale voltages V0S, V4S, V8S, . . . , V56S, V60S. Therefore, it is enough that the decoder for selecting the input voltage of the impedance conversion circuit is connected to the group of gray scale voltage signal lines supplied with the gray scale voltages V0S through V60S. Namely; it is enough that the number of gray scale voltages generated by the reference voltage generating circuit 527 is 16.

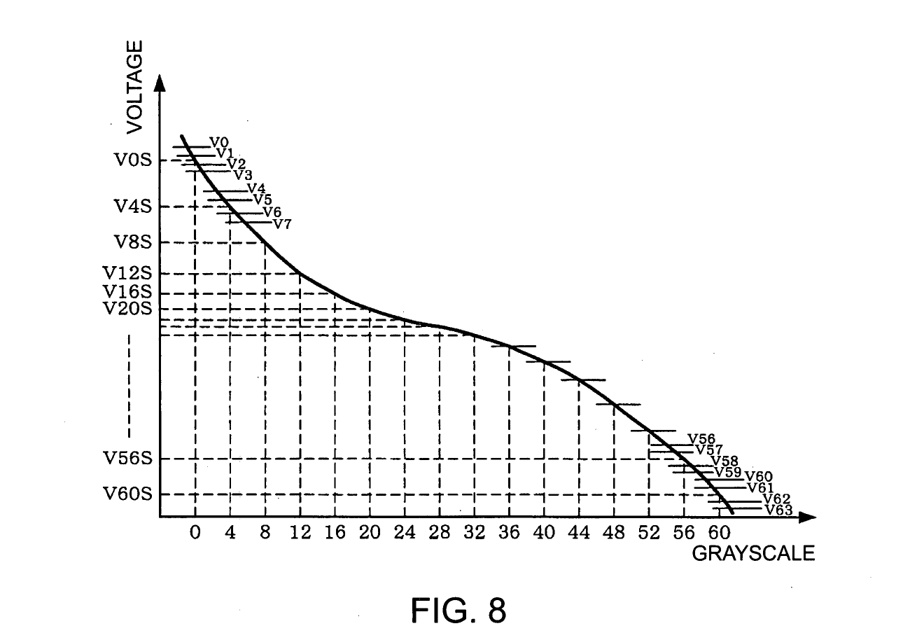

FIG. 8 shows an example of a gray scale characteristic of the data driver according to the present embodiment.

FIG. 8 shows the case in which the impedance conversion circuit performing the operation shown in FIG. 7 is applied to a data driver 520 according to the present embodiment. In this case, the number of gray scale voltages to be supplied to the gray scale voltage signal lines expressed by the horizontal coordinate axis can be reduced while maintaining the number of gray scale levels (=64) expressed by the vertical axis.

As described above, the impedance conversion circuit can supply the data lines with either one of the 2^{(j+k)} kinds of gray scale voltages in accordance with the (j+k) bits of gray scale data. Further, since the impedance conversion circuit is arranged to output the gray scale voltage corresponding to the low k bits of the gray scale data, it is enough for the decoder to select the gray scale data from the 2^{j} kinds of gray scale voltages. Accordingly, since the number of gray scale voltages generated by the reference voltage generating circuit 527 can be reduced, the number of gray scale voltage signal lines can also reduced, thus the width WD1 of the wiring region shown in FIG. 4 can be narrowed. Therefore, since the ratio of the area the wiring region for the gray scale voltage signal lines occupies can be held in a low level, a data driver having a small chip size even with large number of gray scale levels can be provided.

2.1 First Configuration Example

The impedance conversion circuit according to a first configuration example of the present embodiment realizes the operation of the case in which k equals one.

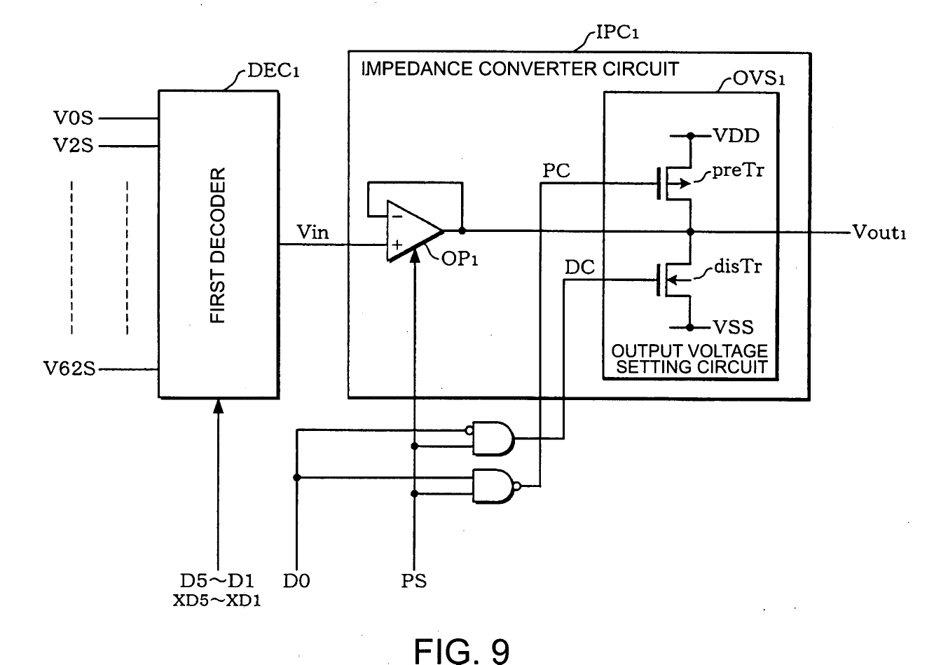

FIG. 9 shows a block diagram showing a schematic configuration of the impedance conversion circuit of the first configuration example of the present embodiment. In FIG. 9, although the configuration example of the impedance conversion circuit IPC₁ is described, configurations of other impedance conversion circuits IPC₂ through IPC_{N} are substantially the same.

The input voltage to the impedance conversion circuit IPC₁ is selected by the first decoder DEC₁. As described above, the first decoder DEC₁ selects either one of the 32 kinds of gray scale voltages V0S, V2S, . . . , V60S, V62S generated by the reference voltage generating circuit 527 in accordance with the high five bits data of the gray scale data and the inverted data thereof, and then output it as the input voltage Vin of the impedance conversion circuit IPC₁.

The impedance conversion circuit IPC₁ includes the operational amplifier OP₁ connected as a voltage follower and an output voltage setting circuit OVS₁. An input of the operational amplifier OP₁ connected as a voltage follower is supplied with the input voltage Vin. The operational amplifier OP₁ drives the data line S₁. The operational amplifier OP1 connected as a voltage follower outputs a voltage different from the input voltage Vin by a predetermined amount of voltage called a dead zone. And, the operational amplifier OP₁ stops or starts driving the output in accordance with a power save signal PS.

The output voltage setting circuit OVS₁ pre-charges or discharges the output of the operational amplifier OP₁ in accordance with the least significant bit data D0 of the gray scale data. In FIG. 9, when pre-charged, the output of the operational amplifier OP1 is set to the system power source voltage VDD as a pre-charge voltage, and when discharged, the output of the operational amplifier OP1 is set to the system ground power source voltage VSS as a discharge voltage. In this case, it is enough for the pre-charge voltage to be higher than the input voltage Vin. Further, it is enough for the discharge voltage to be lower than the input voltage Vin.

The output voltage setting circuit OVS₁ includes a pre-charge transistor preTr and a discharge transistor disTr. The pre-charge transistor preTr is composed of a p-type metal oxide semiconductor (MOS) transistor. The discharge transistor disTr is composed of a n-type MOS transistor. The source of the pre-charge transistor preTr is supplied with the pre-charge voltage, and the drain thereof is connected to the output of the operational amplifier OP₁. The source of the discharge transistor disTr is supplied with the discharge voltage, and the drain thereof is connected to the output of the operational amplifier OP₁.

In FIG. 9, if stopping of the output drive of the operational amplifier OP1 is controlled by the power save signal PS (or the inverted signal XPS), a pre-charge control signal PC, a result of a logic operation of the power save signal PS and the least significant bit data D0 of the gray scale data, is supplied to the gate of the pre-charge transistor preTr. Further, the gate of the discharge transistor disTr is supplied with a discharge control signal DC, which is a result of the logic operation of the power save signal PS with the least significant bit data D0 of the gray scale data. The pre-charge transistor preTr and the discharge transistor disTr are controlled so that conductive states of the sources with the drains are not simultaneously established in the both transistors.

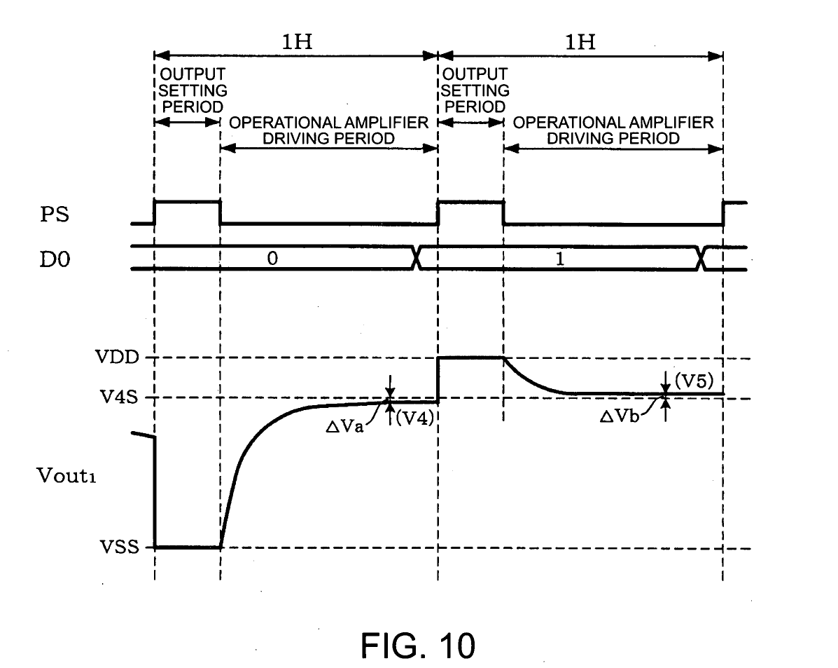

FIG. 10 shows a timing chart of the operational example of the impedance conversion circuit IPC₁ shown in FIG. 9.

In FIG. 10, the horizontal scan period (driving period, in a broad sense) of the liquid crystal panel 512 shown in FIG. 1 is defined as 1H. And, in an output setting period (a first period), which is the beginning part of the drive period, the operational amplifier OP₁ stops driving the output, and the output voltage setting circuit OVS₁ pre-charges or discharges the output of the operational amplifier OP₁. More specifically, when the power save signal PS becomes H level and the least significant bit data D0 of the gray scale data is set to “0,” the output voltage setting circuit OVS₁ discharges the output of the operational amplifier OP₁. On the contrary, when the power save signal PS becomes H level and the least significant bit data D0 of the gray scale data is set to “1,” the output voltage setting circuit OVS₁ pre-charges the output of the operational amplifier OP₁.

And then, in a operational amplifier driving period (a second period of the driving period) following the output setting period, the operational amplifier OP₁ starts driving its output to output the voltage different from the input voltage Vin by a dead zone width ΔVa (ΔVb) of the operational amplifier OP₁ as the output voltage. More specifically, when the power save signal PS becomes L level, the voltage higher than the input voltage Vin by the dead zone width ΔVb is output to change the output voltage from the pre-charge voltage. On the contrary, when the power save signal PS becomes L level, the voltage lower than the input voltage Vin by the dead zone width ΔVa is output to change the output voltage from the discharge voltage.

For example, assuming that input voltage Vin is the gray scale voltage V4S, after the discharge is executed, a voltage lower than the gray scale voltage V4S by the dead zone width ΔVa is output as the gray scale voltage of V4. On the contrary, after the pre-charge is executed, a voltage higher than the gray scale voltage V4S by the dead zone width ΔVb is output as the gray scale voltage of V5.

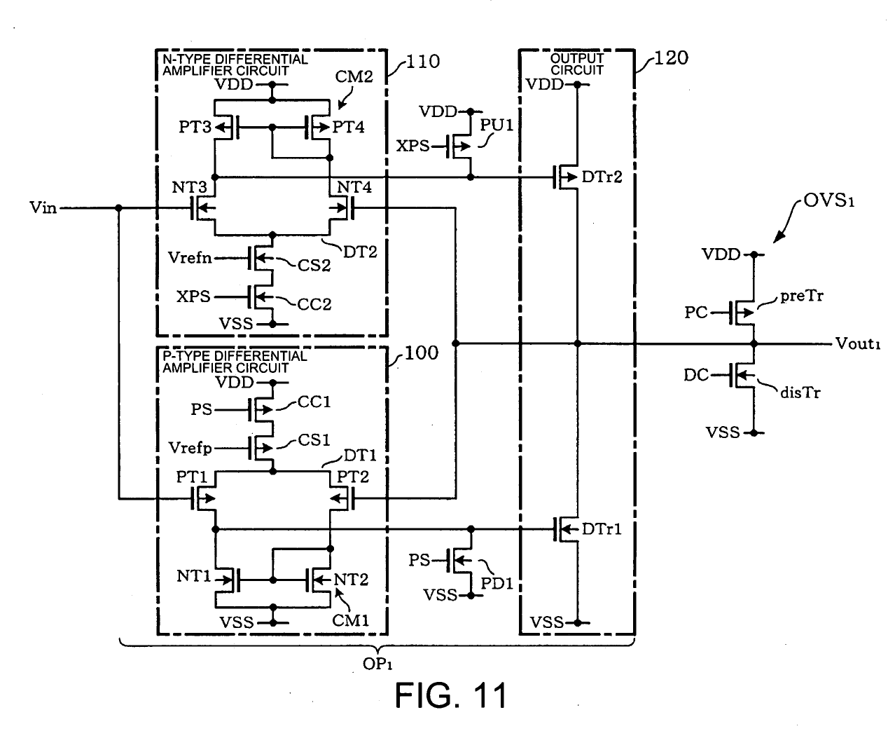

FIG. 11 shows a circuit diagram of a configuration example of the operational amplifier OP₁ according to the first configuration example of the present embodiment. In FIG. 11, a configuration of the output setting circuit OVS₁ is shown in addition to the operational amplifier OP₁.

The operational amplifier OP₁ includes a p-type (a first conduction type, in a broad sense) differential amplifier circuit 100, an n-type (a second conduction type, in a broad sense) differential amplifier circuit 110, and an output circuit 120.

The p-type differential amplifier 100 includes a first differential transistor pair DT1 of p-type and a first current mirror circuit CM1. The first differential transistor pair DT1 includes p-type MOS transistors PT1 and PT2. The source of each of the transistors PT1 and PT2 is supplied with a constant current from a first current source CS1. The first current source CS1 is composed of a p-type MOS transistor whose drain is connected to the sources of the transistors PT1 and PT2, and the gate of the p-type MOS transistor is supplied with a reference voltage Vrefp for generating a predetermined constant current. The source of the p-type MOS transistor composing the first current source CS1 is connected to the drain of a first current source controlling p-type MOS transistor CC1. The source of the transistor CC1 is supplied with the system power supply voltage VDD while its gate is supplied with the power save signal PS. By switching on the transistor CC1, the constant current can be generated by the first current source CS1, and the constant current of the first current source CS1 can be stopped by switching off the transistor CC1. The gate of the transistor PT1 is supplied with the input voltage Vin. The gate of the transistor PT2 is supplied with the output voltage Vout₁.

The first current mirror circuit CM1 generates the drain current for the transistors PT1 and PT2. More specifically, the first current mirror circuit CM1 includes n-type MOS transistors NT1 and NT2 whose gates are connected to each other, and the sources of the transistors NT1 and NT2 are supplied with the system ground power supply voltage VSS. The drain of the transistor NT1 is connected to the drain of the transistor PT1. The drain of the transistor NT2 is connected to the drain of the transistor PT2 and the gate of the transistor NT2.

The n-type differential amplifier 110 includes a second differential transistor pair DT2 of n-type and a second current mirror circuit CM2. The second differential transistor pair DT2 includes n-type MOS transistors NT3 and NT4. The source of each of the transistors NT3 and NT4 is supplied with a constant current from a second current source CS2. The second current source CS2 is composed of a n-type MOS transistor whose drain is connected to the sources of the transistors NT3 and NT4, and the gate of the n-type MOS transistor is supplied with a reference voltage Vrefn for generating a predetermined constant current. The source of the n-type MOS transistor composing the second current source CS2 is connected to the drain of a second current source controlling n-type MOS transistor CC2. The source of the transistor CC2 is supplied with the system ground power supply voltage VSS while its gate is supplied with the inverted signal XPS of the power save signal PS. By switching on the transistor CC2, the constant current can be generated by the second current source CS2, and the constant current of the second current source CS2 can be stopped by switching off the transistor CC2. The gate of the transistor NT3 is supplied with the input voltage Vin. The gate of the transistor NT4 is supplied with the output voltage Vout₁.

The second current mirror circuit CM2 generates the drain current for the transistors NT3 and NT4. More specifically, the second current mirror circuit CM2 includes p-type MOS transistors PT3 and PT4 whose gates are connected to each other, and the sources of the transistors PT3 and PT4 are supplied with the system power supply voltage VDD. The drain of the transistor PT3 is connected to the drain of the transistor NT3. The drain of the transistor PT4 is connected to the drain of the transistor NT4 and the gate of the transistor PT4.

The output circuit 120 includes a first driver transistor Dtr1 and the second driver transistor Dtr2. And, the output circuit 120 outputs as the output voltage Vout₁ the voltage of a connection node in which the drains of the first and the second driver transistors Dtr1, Dtr2 are connected to each other.

The first driver transistor Dtr1 is composed of an n-type MOS transistor. The source of the n-type MOS transistor is supplied with the system ground power supply voltage VSS. Further, the gate voltage of the n-type MOS transistor is controlled in accordance with the drain voltage of the transistor PT1 composing the first differential transistor pair DT1 (an input side of the transistors forming the first differential transistor pair, to which the input voltage Vin is supplied at the gate). The gate of the first driver transistor Dtr1 is connected to the drain of a pull-down n-type MOS transistor PD1. The source of the transistor PD1 is supplied with the system ground power supply voltage VSS while its gate is supplied with the power save signal PS. Accordingly, when the power save signal PS becomes H level, the operation of the first driver transistor Dtr1 can be stabilized by fixing the gate voltage of the first driver transistor Dtr1.

The second driver transistor Dtr2 is composed of a p-type MOS transistor. The source of the p-type MOS transistor is supplied with the system power supply voltage VDD. Further, the gate voltage of the p-type MOS transistor is controlled in accordance with the drain voltage of the transistor NT3 composing the second differential transistor pair DT2 (an input side of the transistors forming the second differential transistor pair, to which the input voltage Vin is supplied at the gate). The gate of the second driver transistor Dtr2 is connected to the drain of a pull-up p-type MOS transistor PU1. The source of the transistor PU1 is supplied with the system power supply voltage VDD while its gate is supplied with the inverted signal XPS of the power save signal PS. Accordingly, when the inverted signal XPS of the power save signal PS becomes L level, the operation of the second driver transistor Dtr2 can be stabilized by fixing the gate voltage of the second driver transistor Dtr2.

And, the first differential transistor pair DT1 is arranged so that the current drive efficiency of the transistor PT1, which is the input side transistor, is lower than the current drive efficiency of the transistor PT2 (the other side, namely the output side of the transistors forming the first differential transistor pair DT1). Therefore, if the gate voltages of the transistors PT1 and PT2 are the same, the drive efficiency of the transistor PT2 is higher than that of the transistor PT1. The first differential transistor pair DT1 can be realized by, for example, arranging W/L of the transistor PT1 smaller than W/L of the transistor PT2, wherein W denotes the channel width of each transistor and L denotes the channel length of each transistor.

Similarly, the second differential transistor pair DT2 is arranged so that the current drive efficiency of the transistor NT3, which is the input side transistor, is lower than the current drive efficiency of the transistor NT4 (the other side, namely the output side of the transistors forming the second differential transistor pair DT2). Therefore, if the gate voltages of the transistors NT3 and NT4 are the same, the drive efficiency of the transistor NT4 is higher than that of the transistor NT3. The second differential transistor pair DT2 can be realized by, for example, arranging W/L of the transistor NT3 smaller than W/L of the transistor NT4.

Thus, the output voltage Vout₁ of the operational amplifier OP₁ can be a voltage different from the input voltage Vin by the dead zone width. The width of the dead zone corresponds to the difference of the current drive efficiencies between the transistors forming each of the differential transistor pairs.

The operational amplifier connected as a voltage follower includes the differential transistor pair as described above. When designing such an operational amplifier, the current drive efficiencies of the both transistors forming the differential transistor pair are typically set to be substantially the same. This is because it is necessary for the impedance conversion device to make the input voltage and the output voltage the same by eliminating the output dead zone of the operational amplifier.

Referring to the configuration of the p-type differential amplifier circuit 100 shown in FIG. 11 as an example, the operation thereof in a typical design example will be described. In the typical design example of the p-type differential amplifier circuit 100 shown in FIG. 11, the current drive efficiencies of the transistors PT1, PT2 are the same. In the typical design example of the n-type differential amplifier circuit 110 shown in FIG. 11, the current drive efficiencies of the transistors NT3, NT4 are also the same.

And, when the input voltage Vin drops, the output voltage Vout₁ also drops, and when the input voltage Vin rises, the output voltage Vout₁ also rises. And, by making the current drive efficiencies of the transistors PT1, PT2 equal, the gate voltages of the both transistors are controlled to be equal, thus making the input voltage Vin and the output voltage Vout₁ the same. Further, by making the current drive efficiencies of the transistors NT3, NT4 equal, the gate voltages of the both transistors are controlled to be equal, thus making the input voltage Vin and the output voltage Vout₁ the same.

On the contrary, in the first configuration example, the current drive efficiencies of the both transistors forming the first differential transistor pair DT1 are made different, at the same time, the current drive efficiencies of the both transistors forming the second differential transistor pair DT2 are also made different.

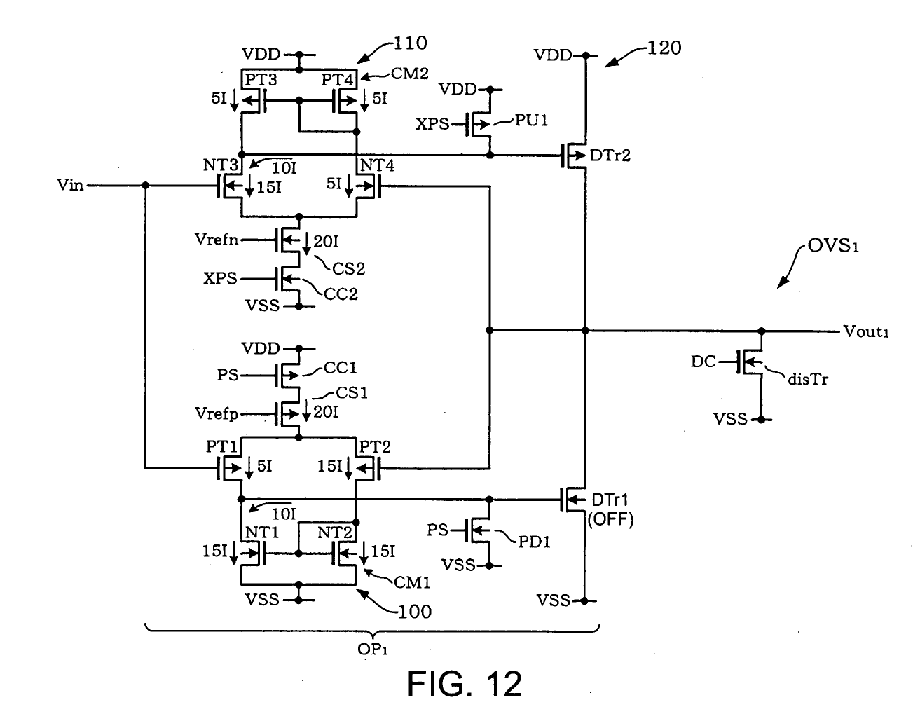

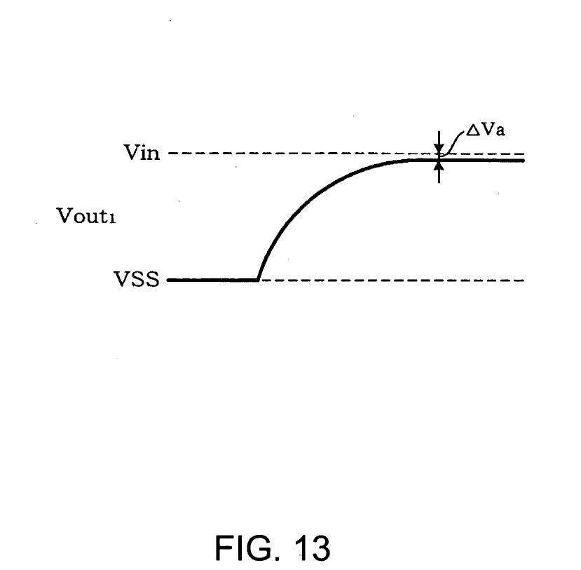

Firstly, the operation of the operational amplifier OP₁ when discharged will be described with reference to FIGS. 12 and 13.

FIG. 12 schematically shows a configuration of the first configuration example of the operational amplifier OP₁ and the output voltage setting circuit OVS₁ when discharged. Note that, the same parts as those in FIG. 11 are denoted with the same reference numerals and explanations therefor are omitted if appropriate.

FIG. 13 schematically shows an example of an operational waveform of the output voltage Vout₁ of the first configuration example of the operational amplifier OP₁ when discharged.

In the p-type differential amplifier circuit 100 according to the first configuration example, the current drive efficiency of the transistor PT1 is lower than the current drive efficiency of the transistor PT2. The amounts of these currents are determined by the first current source CS1. It is assumed that, if the amount of current of the first current source CS1 is 20I, the drain current of the transistor PT1 is 8I, and the drain current of the transistor PT2 is 12I in the equilibrium state.

Meanwhile, in the n-type differential amplifier circuit 110 according to the first configuration example, the current drive efficiency of the transistor NT3 is lower than the current drive efficiency of the transistor NT4. The amounts of these currents are determined by the second current source CS2. It is assumed that, if the amount of current of the second current source CS2 is 20I, the drain current of the transistor NT3 is 8I, and the drain current of the transistor NT4 is 12I in the equilibrium state.

Here, it is assumed that the output voltage Vout₁ is set to be the system ground power supply voltage VSS in accordance with the discharge control signal DC. In this case, in the p-type differential amplifier circuit 100, the drain current of the transistor PT2 increases to be 15I, for example, while the drain current of the transistor PT1 becomes 5I. However, the first current mirror circuit CM1, since the drain currents of the transistors NT1, NT2 become the same amounts (15I), tries to keep the equilibrium state by pulling in the current as much as 10I from the gate of the first drive transistor Dtr1. Therefore, the gate voltage of the first drive transistor Dtr1 drops, and the first drive transistor Dtr1 is controlled towards the off state (controlled to decrease the drain current).

Meanwhile, in the n-type differential amplifier circuit 110, the drain current of the transistor NT4 decreases to be 5I, while the drain current of the transistor NT3 becomes 15I, for example. However, the second current mirror circuit CM2, since the drain currents of the transistors PT3, PT4 become the same amounts (5I), tries to keep the equilibrium state by pulling in the current as much as 10I from the gate of the second drive transistor Dtr2. Therefore, the gate voltage of the second drive transistor Dtr2 drops, and the second drive transistor Dtr2 is controlled towards the on state (controlled to increase the drain current).

In this case, the system is stabilized by the second current mirror circuit CM2 in the state in which the drain currents of the transistors NT3, NT4 are the same. In this case, the transistors NT3, NT4 are both n-type MOS transistors, and the current drive efficiency of the transistor NT3 is lower than the current drive efficiency of the transistor NT4. Therefore, the system is stabilized at the state in which the input voltage Vin, the gate voltage of the transistor NT3, is higher than the output voltage Vout₁, the gate voltage of the transistor NT4. The difference between the input voltage Vin and the output voltage Vout1 defines the dead zone voltage ΔVa. Therefore, as shown in FIG. 6, assuming that the input voltage Vin is, for example, the gray scale voltage V0S, the output voltage Vout₁ can be output as the gray scale voltage of V1.

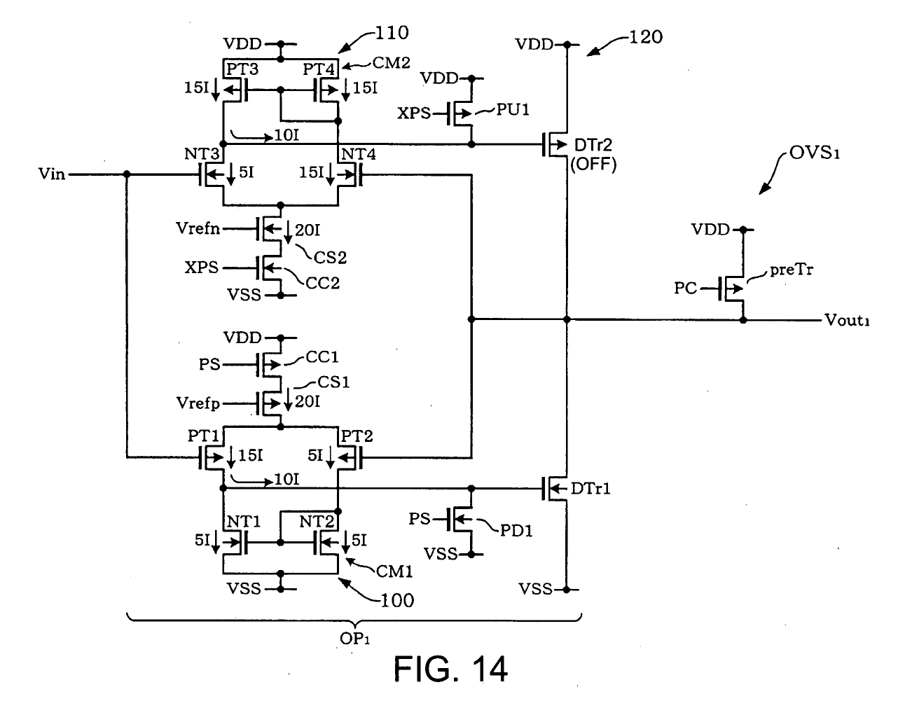

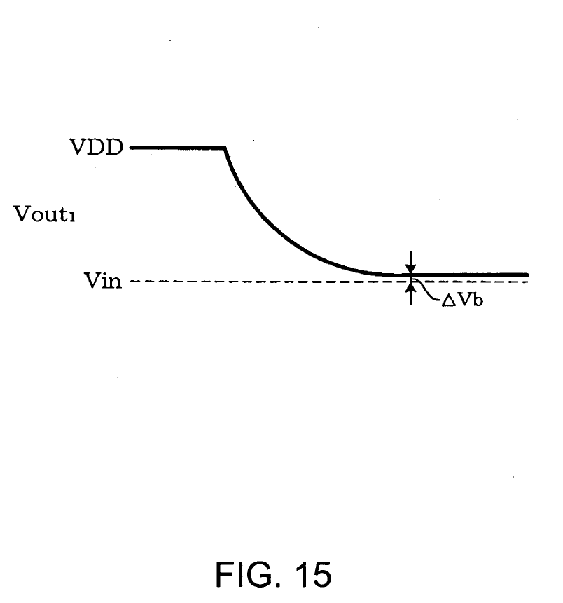

Then, the operation of the operational amplifier OP₁ when pre-charged will be described with reference to FIGS. 14 and 15.

FIG. 14 schematically shows a configuration of the first configuration example of the operational amplifier OP₁ and the output voltage setting circuit OVS₁ when pre-charged. Note that, the same parts as those in FIG. 11 are denoted with the same reference numerals and explanations therefor are omitted if appropriate.

FIG. 15 schematically shows an example of an operational waveform of the output voltage Vout₁ of the first configuration example of the operational amplifier OP₁ when pre-charged.

Here, it is assumed that the output voltage Vout₁ is set to be the system power supply voltage VDD in accordance with the pre-charge control signal DC. In this case, in the n-type differential amplifier circuit 110, the drain current of the transistor NT4 increases to be 15I, while the drain current of the transistor NT3 becomes 5I, for example. However, the second current mirror circuit CM2, since the drain currents of the transistors PT3, PT4 become the same amounts (15I), tries to keep the equilibrium state by running in the current as much as 10I to the gate of the second drive transistor Dtr2. Therefore, the gate voltage of the second drive transistor Dtr2 rises, and the second drive transistor Dtr2 is controlled towards the off state.

Meanwhile, in the p-type differential amplifier circuit 100, the drain current of the transistor PT2 decreases to be 5I, for example, while the drain current of the transistor PT1 becomes 15I. However, the first current mirror circuit CM1, since the drain currents of the transistors NT1, NT2 become the same amounts (5I), tries to keep the equilibrium state by running in the current as much as 10I to the gate of the first drive transistor Dtr1. Therefore, the gate voltage of the first drive transistor Dtr1 rises, and the first drive transistor Dtr1 is controlled towards the on state.

In this case, the system is stabilized by the first current mirror circuit CM1 at the state in which the drain currents of the transistors PT1, PT2 are the same. In this case, the transistors PT1, PT2 are both p-type MOS transistors, and the current drive efficiency of the transistor PT1 is lower than the current drive efficiency of the transistor PT2. Therefore, the system is stabilized at the state in which the input voltage Vin, the gate voltage of the transistor PT1, is lower than the output voltage Vout₁, the gate voltage of the transistor PT2. The difference between the input voltage Vin and the output voltage Vout₁ defines the dead zone voltage ΔVb. Therefore, as shown in FIG. 6, assuming that the input voltage Vin is, for example, the gray scale voltage V0S, the output voltage Vout₁ can be output as the gray scale voltage of V0.

As described above, operational amplifiers are supposed to be designed so as to eliminate the output dead zones. However, in the impedance conversion circuit of the first configuration example, the output of the operational amplifier connected to be a voltage follower is per-charged or discharged in accordance with the least significant bit data of the gray scale data. The input of the operational amplifier is supplied with a voltage selected from 2^{p} (p denotes a positive integer equal to or greater than two.) kinds of voltage levels in accordance with the high (p−1) bits data of the gray scale data. Subsequently, the operational amplifier outputs a voltage different from the input voltage by the dead zone width of the operational amplifier. As described above, in the impedance conversion circuit of the first configuration example, two kinds of output voltage levels can be output corresponding to a single input voltage by positively utilizing the dead zone. By applying such an impedance conversion circuit to an impedance conversion device of the data driver, the number of gray scale voltage levels to be generated by the reference voltage generating circuit 527 can be reduced by half.

Note that “dead zone” described above is different from typical “input-output offset” of an operational amplifier in the following points. “Input-output offset” is generated due to the fluctuation in the thresholds of the transistors or improper sizing between drive transistors composing the output circuits and transistors composing the current mirror circuits. Therefore, even if the “input-output offset” exists, the voltage to be achieved from the pre-charge voltage and the voltage to be achieved from the discharge voltage are the same. On the contrary, since “dead zone” described above is caused by the difference in the current drive efficiencies of the transistors composing the differential transistor pair, the voltage to be achieved from the pre-charge voltage and the voltage to be achieved from the discharge voltage are different.

2 2 Second Configuration Example

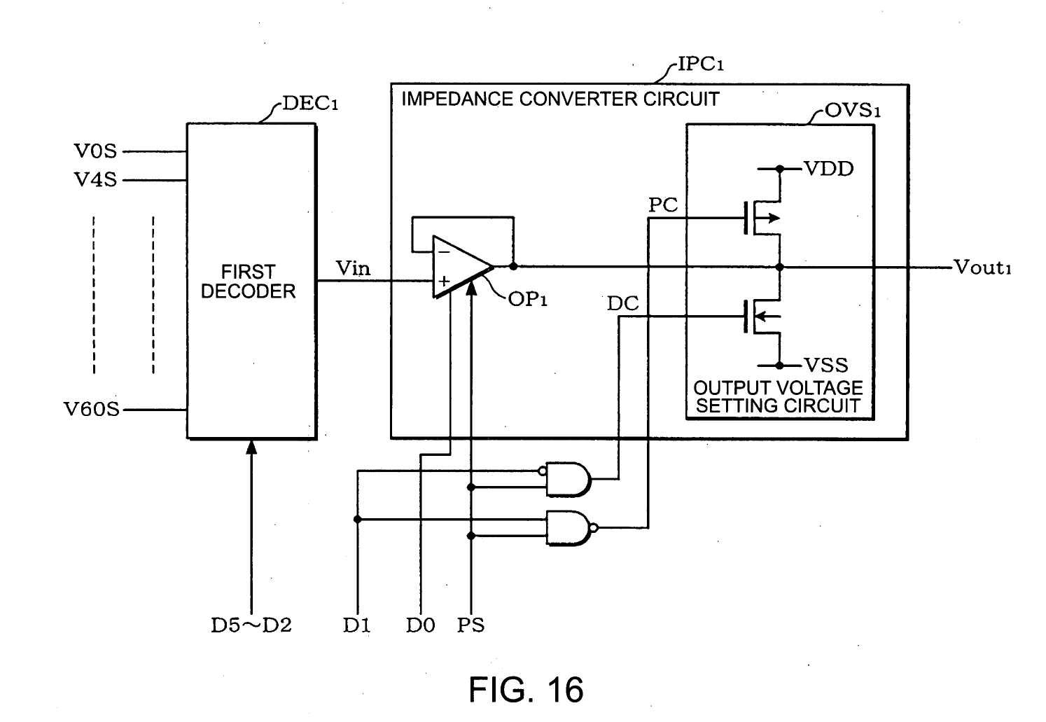

FIG. 16 shows a block diagram showing a schematic configuration of the impedance conversion circuit of a second configuration example of the present embodiment. In FIG. 16, although the configuration example of the impedance conversion circuit IPC₁ is described, configurations of other impedance conversion circuits IPC₂ through IPC_{N} are substantially the same.

The impedance conversion circuit IPC₁ of the second configuration example includes the operational amplifier OP₁ connected as a voltage follower and an output voltage setting circuit OVS₁. The input of the operational amplifier OP₁ is supplied with the input voltage Vin. And, the dead zone width of the output of the operational amplifier OP₁ is determined in accordance with the low (k−1) bits data of the low k bits of the gray scale data.

The output voltage setting circuit OVS₁ pre-charges or discharges the output of the operational amplifier OP₁ in accordance with the most significant bit data of the low k bits of the gray scale data. For example, assuming that k equals two, the pre-charge or the discharge is executed in accordance with the data D1, the most significant bit of the low two bits of the gray scale data.

And, the operational amplifier OP₁ stops driving the output, and then the output voltage setting circuit OVS₁ pre-charges or discharges the output of the operational amplifier OP₁. After then, the operational amplifier OP₁ starts driving the output to output the voltage shifted from the input voltage Vin by the dead zone width of the operational amplifier OP₁ as the output voltage.

It is assumed that j equals four, and k equals 2, for example. In this case, in the first configuration example, the first decoder DEC₁ selects either one of the 32 kinds of gray scale voltages V0S, V2S, . . . , V60S, V62S in accordance with the high five bits data of the gray scale data, and then output it as the input voltage Vin of the impedance conversion circuit IPC₁. On the contrary, in the second configuration example, the first decoder DEC₁ selects either one of the 16 kinds of gray scale voltages V0S, V4S, . . . , V56S, V60S in accordance with the high four bits data of the gray scale data, and then output it as the input voltage Vin of the impedance conversion circuit IPC₁. Therefore, in the second configuration example, the impedance conversion circuit IPC₁ is arranged to output as the output voltage Vout₁ the voltage corresponding to the low two bits data D1, D0 of the gray scale data from the 22 kinds of voltage levels obtained by shifting the potential of the input voltage Vin.

In FIG. 16, if stopping of the output drive of the operational amplifier OP1 is controlled by the power save signal PS (or the inverted signal XPS), the pre-charge control signal PC, a result of a logic operation of the power save signal PS with the lower bit data D1 of the gray scale data, is supplied to the gate of the pre-charge transistor preTr. Further, the gate of the discharge transistor disTr is supplied with the discharge control signal DC, which is a result of the logic operation of the power save signal PS with the lower bit data D1 of the gray scale data. The pre-charge transistor preTr and the discharge transistor disTr are controlled so that conductive states of the sources with the drains are not simultaneously established in the both transistors.

In this case, the dead zone width of the operational amplifier OP₁ is determined in accordance with the least significant bit data D0 of the gray scale data.

Note that, since the output voltage setting circuit OVS₁ is the same as shown in FIG. 9, the description therefor is omitted.

In the second configuration example as described above, the operation timing is substantially the same as in the first configuration example shown in FIG. 10.

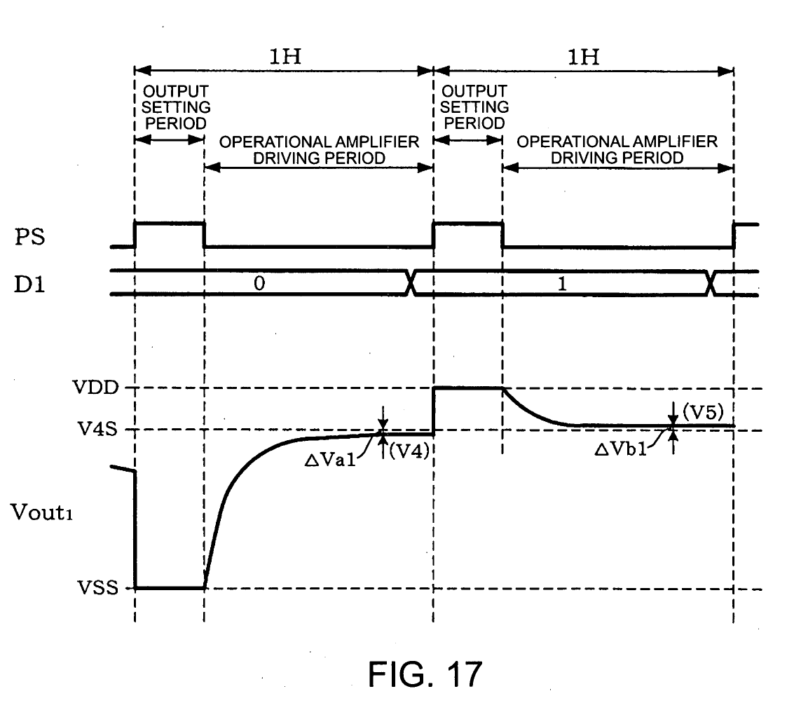

FIG. 17 shows a timing chart of the operational example of the impedance conversion circuit IPC₁ shown in FIG. 16.

The horizontal scan period (driving period, in a broad sense) of the liquid crystal panel 512 shown in FIG. 1 is defined as 1H. And, in an output setting period, which is the beginning part of the drive period, the operational amplifier OP₁ stops driving the output, and the output voltage setting circuit OVS₁ pre-charges or discharges the output of the operational amplifier OP₁. More specifically, when the power save signal PS becomes H level and the lower bit data D1 of the gray scale data is set to “0,” the output voltage setting circuit OVS₁ discharges the output of the operational amplifier OP₁. On the contrary, when the power save signal PS becomes H level and the lower bit data D1 of the gray scale data is set to “1,” the output voltage setting circuit OVS₁ pre-charges the output of the operational amplifier OP₁.

And then, in a operational amplifier driving period of the driving period following the output setting period, the operational amplifier OP₁ starts driving its output to output the voltage different from the input voltage Vin by a dead zone width ΔVa1 (ΔVb1) of the operational amplifier OP₁ as the output voltage. The dead zone width is determined in accordance with the least significant bit data D0 of the gray scale data.

For example, assuming that input voltage Vin is the gray scale voltage V4S, after the discharge is executed, a voltage lower than the gray scale voltage V4S by the dead zone width ΔVa1 is output as the gray scale voltage of V4. On the contrary, after the pre-charge is executed, a voltage higher than the gray scale voltage V4S by the dead zone width ΔVb1 is output as the gray scale voltage of V5. Since each dead zone width is variable, two values of the output voltage Vout₁ to be achieved from the pre-charge voltage in the operational amplifier driving period and two values of the output voltage Vout₁ to be achieved from the discharge voltage in the operational amplifier driving period can be provided. Therefore, totally four values of output voltage Vout₁ can be output based on the input voltage Vin.

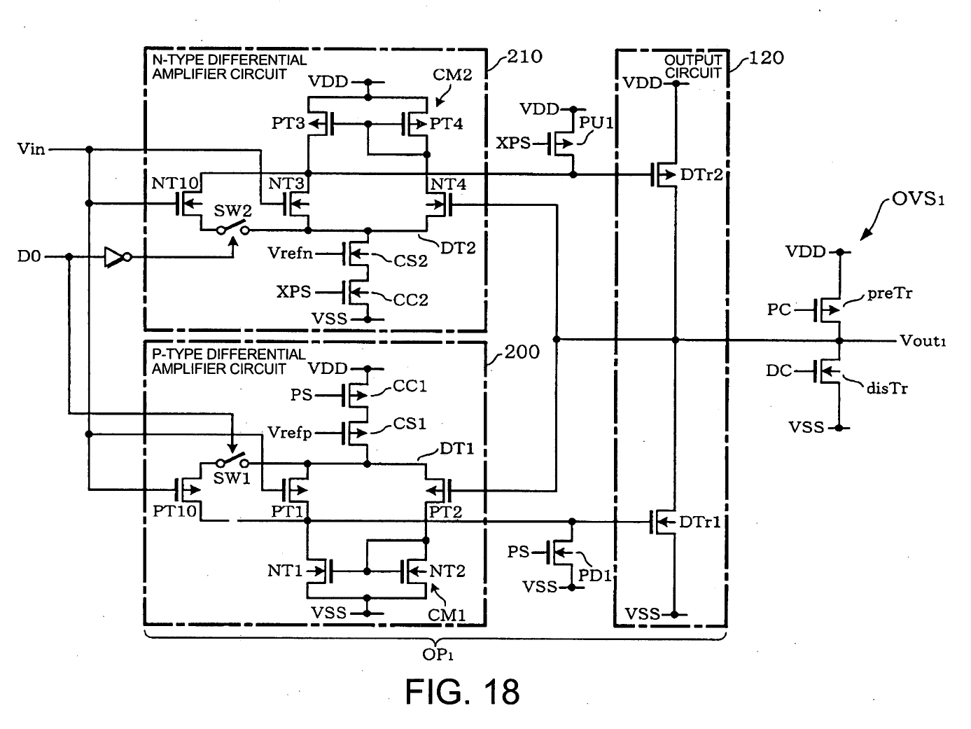

FIG. 18 shows a circuit diagram of a configuration example of the operational amplifier OP₁ according to the second configuration example of the present embodiment. In FIG. 18, a configuration of the output setting circuit OVS₁ is shown in addition to the operational amplifier OP₁. FIG. 18 shows the case in which k equals two.

The operational amplifier OP₁ includes a p-type (a first conduction type) differential amplifier circuit 200, an n-type (a second conduction type) differential amplifier circuit 210, and the output circuit 120. Since the output circuit 120 is the same as in the first configuration example, the description therefor is omitted. Note that, in FIG. 18, the same sections as those in FIG. 11 are denoted with the same reference numerals and explanations therefor are omitted if appropriate.

The p-type differential amplifier 200 includes a first differential transistor pair DT1 of p-type and a first current mirror circuit CM1. Since the first differential transistor pair DT1 and the first current mirror circuit CM1 are the same as shown in FIG. 11, the descriptions therefor are omitted.

The n-type differential amplifier 210 includes a second differential transistor pair DT2 of n-type and a second current mirror circuit CM2. Since the second differential transistor pair DT2 and the second current mirror circuit CM2 are the same as shown in FIG. 11, the descriptions therefor are omitted.

And, it is arranged that the current drive efficiency of the transistor PT1 (a first input current drive efficiency of the input side transistor) of the first differential transistor pair DT1 is lower than the current drive efficiency of the transistor PT2 (a first output current drive efficiency of the other output side transistor of the transistors forming the first differential transistor pair DT1). Further, by changing the difference in the current drive efficiencies of the transistors PT1, PT2 in accordance with the low one (=k−1) bit data of the low two (=k) bits of the gray scale data, the dead zone width can be modified.

Similarly, it is arranged that the current drive efficiency of the transistor NT3 (a second input current drive efficiency of the input side transistor) of the second differential transistor pair DT2 is lower than the current drive efficiency of the transistor NT4 (a second output current drive efficiency of the other output side transistor of the transistors forming the second differential transistor pair DT2). Further, by changing the difference in the current drive efficiencies of the transistors NT3, NT4 in accordance with the low one (=k−1) bit data of the low two (=k) bits of the gray scale data, the dead zone width can be modified.

For this reason, the p-type differential amplifier circuit 200 can include a p-type MOS transistor PT10 (a first auxiliary transistor) whose gate is supplied with the input voltage Vin. The source or the drain of the transistor PT10 is electrically connected or disconnected between the source and the drain of the transistor PT1 (the input side transistor of the first differential transistor pair DT1) in accordance with the low one (=k−1) bit data of the low two (=k) bits of the gray scale data. For example, it can be configured that the source of the transistor PT10 and the source of the transistor PT1 are connected via a switch element SW1.

In this case, the current drive efficiency of the transistor PT1 is lower than the current drive efficiency of the transistor PT2. Therefore, it is arranged that the current drive efficiencies of the input side transistors PT1, PT10 are lower than the current drive efficiency of the output side transistor PT2 regardless of whether the switch element SW1 is set to the on state or the off state, but the difference in the current drive efficiencies becomes smaller when the switch element SW1 is set to the on state than when it is set to the off state.

Further, the n-type differential amplifier circuit 210 can include a n-type MOS transistor NT10 (a second auxiliary transistor) whose gate is supplied with the input voltage Vin. The source or the drain of the transistor NT10 is electrically connected or disconnected between the source and the drain of the transistor NT3 (the input side transistor of the second differential transistor pair DT2) in accordance with the low one (=k−1) bit data of the low two (=k) bits of the gray scale data. For example, it can be configured that the source of the transistor NT10 and the source of the transistor NT1 are connected via a switch element SW2.

In this case, the current drive efficiency of the transistor NT3 is lower than the current drive efficiency of the transistor NT4. Therefore, it is arranged that the current drive efficiencies of the input side transistors NT3, NT10 are lower than the current drive efficiency of the output side transistor NT4 regardless of whether the switch element SW2 is set to the on state or the off state, but the difference in the current drive efficiencies becomes smaller when the switch element SW2 is set to the on state than when it is set to the off state.

Note that an alternative configuration having at least either one of the transistor PT10 and the transistor NT10 can also be adopted.

Since the operations of the p-type differential amplifier circuit 200 and the n-type differential amplifier circuit 210 are the same as in the first configuration example explained with reference to FIGS. 12 through 16 in both states in which the switch elements are respectively set to the on state or the off state, the description therefor is omitted.

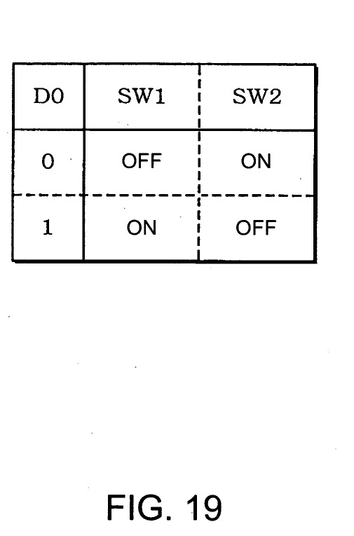

FIG. 19 shows a diagram for explaining a control example of the switch elements SW1, SW2 if k equals two.

In this case, the switch elements SW1, SW2 are on-off controlled in accordance with the least significant bit data D0 of the gray scale data. By controlling as shown in FIG. 19, the difference in the current drive efficiencies of the both transistors forming the differential transistor pair can be modified.

And, each of the differential amplifier circuits can be provided with two dead zones with respect to the input voltage Vin. Therefore, the number of voltage levels of the output voltage Vout₁ with respect to the input voltage Vin can be increased to totally four, namely two voltage levels to be achieved from the pre-charge voltage and two voltage levels to be achieved from the discharge voltage.

Note that, although the current drive efficiencies of the input side transistors composing the differential transistor pairs are changed in FIG. 18, it is not so limited.

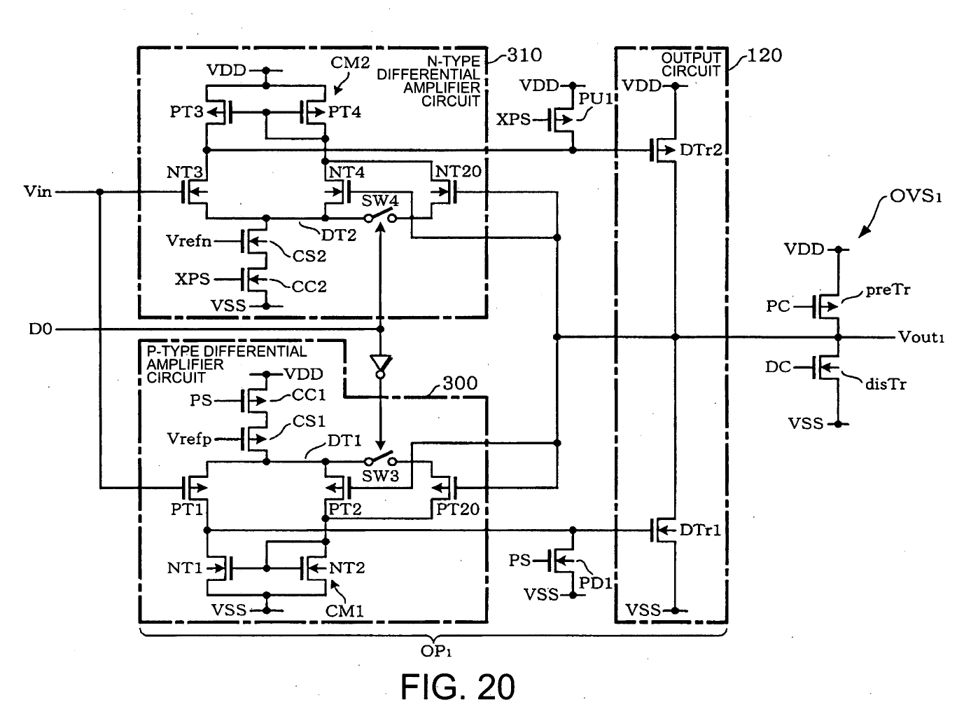

FIG. 20 shows a circuit diagram of a configuration example of the operational amplifier OP₁ according to a modified example of the second configuration example. In FIG. 20, a configuration of the output setting circuit OVS₁ is shown in addition to the operational amplifier OP₁. Note that, in FIG. 20, the same sections as those in FIG. 18 are denoted with the same reference numerals and explanations therefor are omitted if appropriate. FIG. 20 shows the case in which k equals two.

The operational amplifier OP1 includes, similarly to the second modified example, a p-type differential amplifier circuit 300, an n-type differential amplifier circuit 310, and the output circuit 120. The output circuit 120 is the same as in the second configuration example shown in FIG. 18.

The p-type differential amplifier circuit 300 is different from the p-type differential amplifier 200 shown in FIG. 18 in the point in which the transistor PT10 as the first auxiliary transistor (and the switch element SW1) is omitted and a p-type MOS transistor PT20 whose gate is supplied with the output voltage Vout₁ is provided as a third auxiliary transistor. The source or the drain of the transistor PT20 is electrically connected or disconnected between the source and the drain of the transistor PT2 (the output side transistor of the first differential transistor pair DT1) in accordance with the low one (=k−1) bit data of the low two (=k) bits of the gray scale data. For example, it can be configured that the source of the transistor PT20 and the source of the transistor PT2 are connected via a switch element SW3.

In this case, the current drive efficiency of the transistor PT1 is lower than the current drive efficiency of the transistor PT2. Therefore, it is arranged that the current drive efficiencies of the input side transistor PT1 is lower than the current drive efficiency of the output side transistors PT2, PT20 regardless of whether the switch element SW3 is set to the on state or the off state, but the difference in the current drive efficiencies becomes larger when the switch element SW3 is set to the on state than when it is set to the off state.

The n-type differential amplifier circuit 310 is different from the n-type differential amplifier 210 shown in FIG. 18 in the point in which the transistor NT10 as the second auxiliary transistor (and the switch element SW2) is omitted and an n-type MOS transistor NT20 whose gate is supplied with the output voltage Vout₁ is provided as a fourth auxiliary transistor. The source or the drain of the transistor NT20 is electrically connected or disconnected between the source and the drain of the transistor NT4 (the output side transistor of the second differential transistor pair DT2) in accordance with the low one (=k−1) bit data of the low two (=k) bits of the gray scale data. For example, it can be configured that the source of the transistor NT20 and the source of the transistor NT4 are connected via a switch element SW4.

In this case, the current drive efficiency of the transistor NT3 is lower than the current drive efficiency of the transistor NT4. Therefore, it is arranged that the current drive efficiencies of the input side transistor NT3 is lower than the current drive efficiency of the output side transistors NT4, NT20 regardless of whether the switch element SW4 is set to the on state or the off state, but the difference in the current drive efficiencies becomes larger when the switch element SW4 is set to the on state than when it is set to the off state.

Note that, although the difference in the current drive efficiencies of the both transistors forming each of the differential transistor pairs is changed by the first and the second auxiliary transistors in the second configuration example, or by the third and the fourth auxiliary transistors in the modified example of the second configuration example, the invention is not limited thereto. It is enough that the current drive efficiency of the input side transistor can be lower than the current drive efficiency of the output side transistor and the difference in the current drive efficiencies of the both transistors forming each differential transistor pair can be changed using at least one of the first through fourth auxiliary transistors.

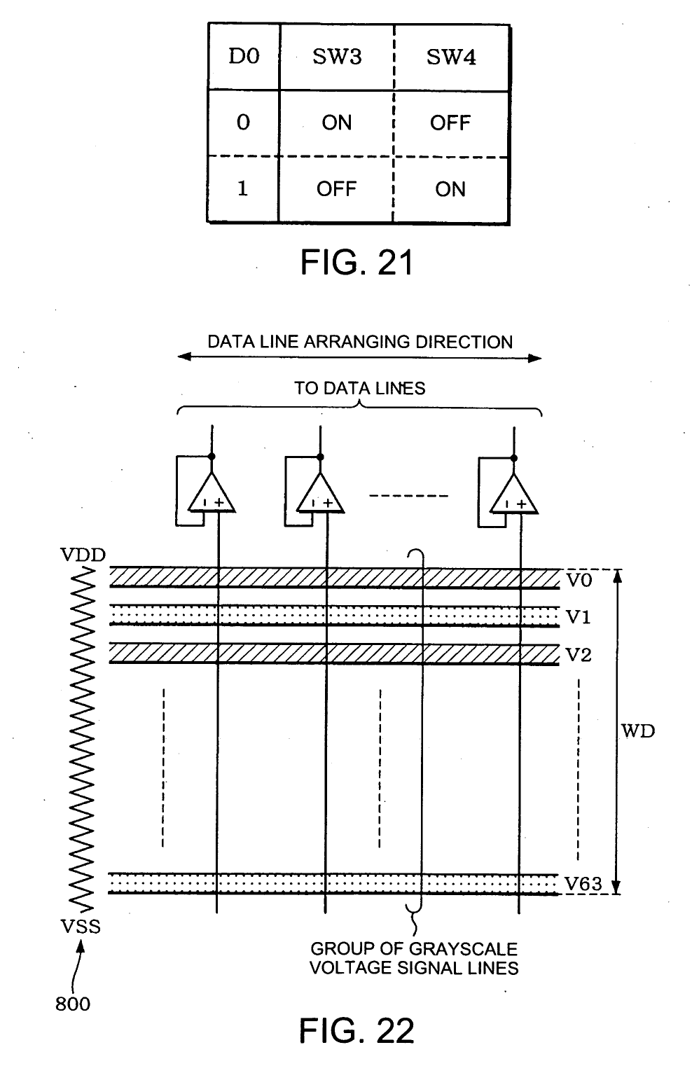

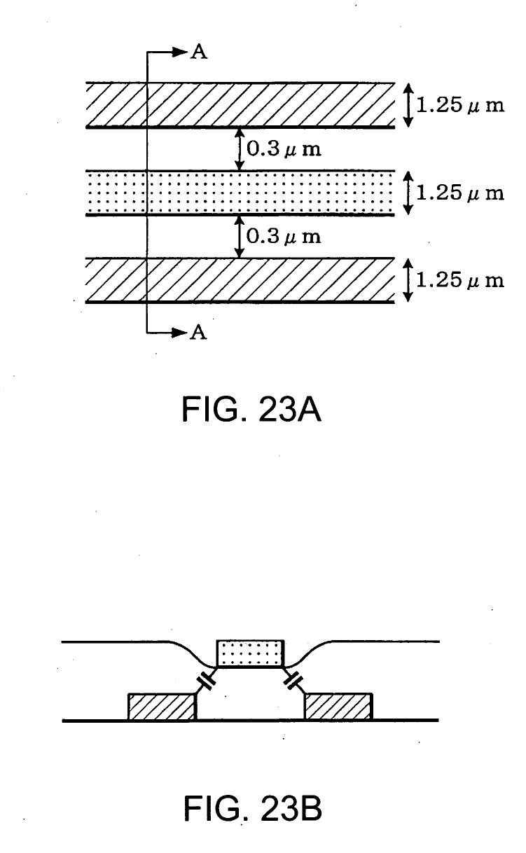

FIG. 21 shows a diagram for explaining a control example of the switch elements SW3, SW4 in case k equals two.

In this case, the switch elements SW3, SW4 are on-off controlled in accordance with the least significant bit data D0 of the gray scale data. By controlling as shown in FIG. 21, the difference in the current drive efficiencies of the both transistors forming the differential transistor pair can be changed.

And, each of the differential amplifier circuits can be provided with two dead zones with respect to the input voltage Vin. Therefore, the number of voltage levels of the output voltage Vout₁ with respect to the input voltage Vin can be increased to totally four, namely two voltage levels to be achieved from the pre-charge voltage and two voltage levels to be achieved from the discharge voltage.

As described above, in the impedance conversion circuit of the second configuration example or the modified example thereof, two kinds of output voltage levels can be output with respect to a single input voltage by positively utilizing the dead zone. By applying such an impedance conversion circuit to an impedance conversion device of the data driver, the number of gray scale voltage levels to be generated by the reference voltage generating circuit 527 can be reduced to be a fourth.

Note that, in the second configuration example and the modified example thereof, in case k equals three, for example, the first through fourth auxiliary transistors are on-off controlled in accordance with the low two bits data D1, D2 of the low three bits of the gray scale data. Further, the pre-charge or the discharge is executed in accordance with the data D2 of the gray scale data. The above embodiments can be realized with other values of k.

Note that the present invention is not limited to the embodiment described above, but can be put into practice with various modification within the scope or the spirit of the present invention. For example, the invention is not limited to those applied for driving liquid crystal panels as described above, but can also be applied for driving electroluminescence or plasma display devices.

Further, in the aspects of the present invention corresponding to the dependent claims, configurations lacking a part of elements of the independent claim thereof can also be adopted. Further, a substantial part of one independent claim can be dependent from another independent claim.

What is claimed is:

1. An impedance conversion circuit for outputting a voltage corresponding to (j+k) *j, k: positive integers) bits of gray scale data, comprising:
an input for receiving an input voltage selected from 2^{j} levels of voltages in accordance with high j bit(s) of the gray scale data; and
an output for outputting an output voltage corresponding to low k bit(s) of the gray scale data from 2^{k} levels of voltages obtained by changing a potential of the input voltage.

2. The impedance conversion circuit according to claim 1, comprising:
an operational amplifier connected to form a voltage follower and having an input supplied with the input voltage; and
an output voltage setting circuit for one of pre-charging and discharging an output of the operational amplifier in accordance with the least significant bit data of the gray scale data, wherein
the operational amplifier outputs the output voltage different from the input voltage by a dead zone width of the operational amplifier after the output voltage setting circuit one of pre-charges and discharges the output of the operational amplifier.

3. The impedance conversion circuit according to claim 2, wherein
the operational amplifier includes
a first differential amplifier circuit of a first conductivity type having a first differential transistor pair of the first conductivity type having a first pair of transistors whose sources are supplied with a current from a first current source and whose gates are respectively supplied with the input voltage and the output voltage, and a first current mirror circuit for generating a drain current for the first pair of transistors,
a second differential amplifier circuit of a second conductivity type having a second differential transistor pair of the second conductivity type having a second pair of transistors whose sources are supplied with a current from a second current source and whose gates are respectively supplied with the input voltage and the output voltage, and a second current mirror circuit for generating a drain current for the second pair of transistors, and
an output circuit having a first drive transistor of the second conductivity type whose gate voltage is controlled in accordance with the drain voltage of an input side of the first pair of transistors whose drain is supplied with the input voltage, and a second drive transistor of the first conductivity type whose gate voltage is controlled in accordance with the drain voltage of an input side of the second pair of transistors whose drain is supplied with the input voltage, drains of the first and the second drive transistors being connected to each other via a node, and the output circuit outputting a voltage of the node as the output voltage,
a current drive efficiency of the input side of the first pair of transistors is arranged to be lower than a current drive efficiency of the other output side of the first pair of transistors, and
a current drive efficiency of the input side of the second pair of transistors is arranged to be lower than a current drive efficiency of the other output side of the second pair of transistors.

4. The impedance conversion circuit according to claim 1, comprising:
an operational amplifier connected to form a voltage follower and having an input supplied with the input voltage and provided with a dead zone having a width corresponding to low (k−1) bit(s) data of a low k bits of the gray scale data; and
an output voltage setting circuit for one of pre-charging and discharging an output of the operational amplifier in accordance with the most significant bit data of the low k bits of the gray scale data, wherein
the operational amplifier outputs the output voltage different from the input voltage by a dead zone width of the operational amplifier after the output voltage setting circuit one of pre-charges and discharges the output of the operational amplifier.

5. The impedance conversion circuit according to claim 4, wherein:
the operational amplifier includes
a first differential amplifier circuit of a first conductivity type having a first differential transistor pair of the first conductivity type having a first pair of transistors whose sources are supplied with a current from a first current source and whose gates are respectively supplied with the input voltage and the output voltage, and a first current mirror circuit for generating a drain current for the first pair of transistors,
a second differential amplifier circuit of a second conductivity type having a second differential transistor pair of the second conductivity type having a second pair of transistors whose sources are supplied with a current from a second current source and whose gates are respectively supplied with the input voltage and the output voltage, and a second current mirror circuit for generating a drain current for the second pair of transistors, and
an output circuit having a first drive transistor of the second conductivity type whose gate voltage is controlled in accordance with the drain voltage of an input side of the first pair of transistors whose drain is supplied with the input voltage, and a second drive transistor of the first conductivity type whose gate voltage is controlled in accordance with the drain voltage of an input side of the second pair of transistors whose drain is supplied with the input voltage, drains of the first and the second drive transistors being connected to each other via a node, and the output circuit outputting a voltage of the node as the output voltage,
a first current drive efficiency of the input side of the first pair of transistors is arranged to be lower than a first current drive efficiency of the other output side of the first pair of transistors, and the width of the dead zone is changed by changing a first difference between the first input side current drive efficiency and the first output side current drive efficiency in accordance with the low (k−1) bit(s) data of the low k bits of the gray scale data, and
a second current drive efficiency of the input side of the second pair of transistors is arranged to be lower than a second current drive efficiency of the other output side of the second pair of transistors, and the width of the dead zone is changed by changing a second difference between the second input side current drive efficiency and the second output side current drive efficiency in accordance with the low (k−1) bit(s) data of the low k bits of the gray scale data.

6. The impedance conversion circuit according to claim 5, wherein
the first differential amplifier circuit of the first conductivity type includes
a first auxiliary transistor whose gate is supplied with the input voltage,
one of a source and a drain of the first auxiliary transistor is one of electrically connected and disconnected between the source and the drain of the input side of the first pair of transistors in accordance with the low (k−1) bit(s) data of the low k bits of the gray scale data.

7. The impedance conversion circuit according to claim 5, wherein
the second differential amplifier circuit of the second conductivity type includes
a second auxiliary transistor whose gate is supplied with the input voltage,
one of a source and a drain of the second auxiliary transistor is one of electrically connected and disconnected between the source and the drain of the input side of the second pair of transistors in accordance with the low (k−1) bit(s) data of the low k bits of the gray scale data.

8. The impedance conversion circuit according to claim 6, wherein
the second differential amplifier circuit of the second conductivity type includes
a second auxiliary transistor whose gate is supplied with the input voltage,
one of a source and a drain of the second auxiliary transistor is one of electrically connected and disconnected between the source and the drain of the input side of the second pair of transistors in accordance with the low (k−1) bit(s) data of the low k bits of the gray scale data.

9. The impedance conversion circuit according to claim 5, wherein
the first differential amplifier circuit of the first conductivity type includes
a third auxiliary transistor whose gate is supplied with the input voltage,
one of a source and a drain of the third auxiliary transistor is one of electrically connected and disconnected between the source and the drain of the output side of the first pair of transistors in accordance with the low (k−1) bit(s) data of the low k bits of the gray scale data.

10. The impedance conversion circuit according to claim 5, wherein
the second differential amplifier circuit of the second conductivity type includes
a fourth auxiliary transistor whose gate is supplied with the input voltage,
one of a source and a drain of the fourth auxiliary transistor is one of electrically connected and disconnected between the source and the drain of the output side of the second pair of transistors in accordance with the low (k−1) bit(s) data of the low k bits of the gray scale data.

11. The impedance conversion circuit according to claim 9, wherein
the second differential amplifier circuit of the second conductivity type includes
a fourth auxiliary transistor whose gate is supplied with the input voltage,
one of a source and a drain of the fourth auxiliary transistor is one of electrically connected and disconnected between the source and the drain of the output side of the second pair of transistors in accordance with the low (k−1) bit(s) data of the low k bits of the gray scale data.

12. The impedance conversion circuit according to claim 1, wherein
the output voltage setting circuit
sets the output of the operational amplifier to a pre-charge voltage higher than the input voltage in a pre-charge state, and
sets the output of the operational amplifier to a discharge voltage lower than the input voltage in a discharge state.

13. A driver circuit for driving an electro-optic device having a plurality of scanning lines, a plurality of data lines, a plurality of pixel electrodes specified by the scanning lines and the data lines, comprising:
the impedance conversion circuit according to claim 1; and
a voltage selecting circuit for outputting a voltage selected from 2^{j} levels of voltages in accordance with high j bit(s) of the gray scale data as the input data, wherein
the output voltage is supplied to either of the plurality of data lines.

14. A driver circuit for driving an electro-optic device having a plurality of scanning lines, a plurality of data lines, a plurality of pixel electrodes specified by the scanning lines and the data lines, comprising:
the impedance conversion circuit according to claim 2; and
a voltage selecting circuit for outputting a voltage selected from 2^{j} levels of voltages in accordance with high j bit(s) of the gray scale data as the input voltage, wherein
the output voltage setting circuit one of pre-charges and discharges the output of the operational amplifier in a first beginning period of a driving period, and
the operational amplifier supplies either of the plurality of data lines with the output voltage in a second period of the driving period after the first period.

15. The driver circuit according to claim 13, further comprising:
a reference voltage generating circuit for generating 2^{j} levels of voltages obtained by dividing a voltage between the first and the second power supply voltages.

16. The driver circuit according to claim 14, further comprising:
a reference voltage generating circuit for generating 2^{j} levels of voltages obtained by dividing a voltage between the first and the second power supply voltages.

17. A method of controlling an impedance conversion circuit for outputting a voltage corresponding to p (p: positive integer, equal to or greater than two) bits of gray scale data, comprising:
one of pre-charging and discharging an output of an operational amplifier in accordance with the least significant bit data of the gray scale data, the operational amplifier being connected to form a voltage follower whose input is supplied with an input voltage selected from 2^{p} levels of voltages in accordance with high (p−1) bit(s) data of the gray scale data; and
the operational amplifier outputting a voltage different from the input voltage by the dead zone width of the operational amplifier, wherein the outputting step is executed after the one of pre-charging and discharging step.

18. A method of controlling an impedance conversion circuit for outputting a voltage corresponding to (j+k) (j, k: positive integers) bits of gray scale data, comprising:
one of pre-charging and discharging an output of an operational amplifier in accordance with the most significant bit data of low k bits of the gray scale data, the operational amplifier being connected to form a voltage follower whose input is supplied with an input voltage selected from 2^{j} levels of voltages in accordance with high j bit(s) data of the gray scale data; and
the operational amplifier outputting the output voltage different from the input voltage by the dead zone width in accordance with the low (k−1) bit(s) of low k bits of the gray scale data, wherein the outputting step is executed after the one of pre-charging and discharging step.
